(19) United States
(12) Patent Application Publication
(10) Pub. No.: US 2002/0138833 A1
(43) Pub. Date: Sep. 26, 2002

(54) PROGRAM GUIDE INFORMATION GENERATING/TRANSMITTING SYSTEM SUPPORTING SIMULTANEOUS BROADCASTING AND PROGRAM GUIDE INFORMATION GENERATING DEVICE AND PROGRAM GUIDE INFORMATION TRANSMITTING DEVICE CONSTITUTING THE SYSTEM

(76) Inventors: Mitsuhiro Kageyama, Tokyo (JP); Toru Kawaguchi, Matsudo-shi, Chiba (JP); Daisuke Lino, Matsudo-shi (JP)

Correspondence Address: Morris Liss, Connolly Bove Lodge & Hutz, PO Box 19088, Washington, DC, 20036-3425, US

(21) Appl. No.: 09/980,296

(22) PCT Filed: Mar. 29, 2001
(86) PCT No.: PCT/JP01/02682

(30) Foreign Application Priority Data
Mar. 31, 2000 (JP) 2000-98383

(51) Int. Cl. H04N 7/16; H04N 7/025; H04N 7/10; G06F 3/00; H04N 5/445; G06F 13/00

(52) U.S. Cl. 725/38; 725/136; 725/135; 725/32; 725/25

(57) ABSTRACT

A program information-generating device is disclosed which can produce program guide information accurately even when a method for editing the program broadcasting schedule of simultaneous broadcasting efficiently is employed. In this device, a program guide information-generating device 203 has a simulcast range processing block 212 which receives program information and the program broadcasting schedule of each channel and generates a program broadcasting schedule by replacing simulcast range information with the corresponding program broadcasting schedule of a simulcast original channel when the simulcast range information which at least indicates that a program is to be simultaneous broadcast and which has a simulcast original channel identifier is registered in the range where simultaneous broadcasting takes place on the program broadcasting schedule. Even when the editing of simultaneous broadcasting is made efficient, the program guide information can be produced by the above replacement.

### TECHNICAL FIELD

The present invention relates to a program guide information-generating/transmitting system for generating and transmitting program guide information and devices constituting the system. More specifically, a program guide information-generating/transmitting system suitable for simultaneous broadcasting in which a program which is broadcast on a certain channel is also broadcast on other channel and devices constituting the system.

### BACKGROUND ART

A conventional program guide information-generating/transmitting system, as shown in FIG. 2, comprises a program editing device 101 which edits a program broadcasting schedule of each channel and program information, a program guide information managing device (data server) 102 which manages the information edited by the program editing device 101, outputs the program schedule and the program information to a program guide information-generating device 103 and outputs the program schedule to a program initiation control device 104, the program guide information-generating device 103 which receives the program broadcasting schedule and the program information from the data server 102 and generates program guide information (schedule event information, single-event information and current/next event information transmission schedule), the program initiation control device 104 which follows the program broadcasting schedule received from the data server 102 and transmits a program initiation notice by means of an external trigger which is not shown, and a program guide information-transmitting device 105 which receives the program guide information from the program guide information-generating device 103, transmits the schedule event information and generates and transmits current/next event information from the single-event information and the current/next event information transmission schedule in accordance with the program initiation notice transmitted from the program initiation control device 104.

In this program guide information-generating/transmitting system, the program information is uniquely identified by a channel identifier and a event identifier.

The program editing device 101 edits program information and a program broadcasting schedule. The program editing device 101 outputs the program information and the program broadcasting schedule of each channel to the data server 102. The program broadcasting schedule contains the event identifier, date and time to broadcast and duration of a program to be broadcast. The program information contains the event identifier as well as, for example, the title, contents and personalities of the program. The data server 102 stores the program information and the program broadcasting schedule. The data server 102 outputs the program information and the program broadcasting schedule to the program guide information-generating device 103 and outputs the program broadcasting schedule to the program initiation control device 104 either periodically or according to the input from the program editing device 101 or an external trigger which is not shown.

The program guide information-generating device 103 generates program guide information (schedule event information, single-event information and current/next event information transmission schedule) from the obtained program information and program broadcasting schedule and outputs the program guide information to the program guide information-transmitting device 105 either periodically or according to the input from the program guide information-generating device 103 or an external trigger which is not shown.

In the schedule event information, pieces of program information comprising, for example, a event identifier, a program start time, a program duration and program information are described for the programs to be broadcast on each channel within a certain time period, e.g., one week, in the order of the start time with the earliest start time being the first. Further, in the single-event information, a channel identifier, a event identifier, a program start time, a program duration and program information are described for one program. In the current/next event information transmission schedule, the switching schedule of the current/next event information of each channel is described.

The program initiation control device 104 receives the program broadcasting schedule from the data server 102 and outputs a program initiation notice at the timing when a program start in accordance with the program broadcasting schedule of each channel. In the program initiation notice, a channel identifier and event identifier to be are described, for example.

When the program guide information-transmitting device 105 receives the program guide information from the program guide information-generating device 103, it acquires the schedule event information from the program guide information, replaces the currently transmitted schedule event information of the channel with the acquired schedule event information and outputs the acquired schedule event information. Further, when the program guide information-transmitting device 105 receives the program initiation notice from the program initiation control device 104, it extracts an entry in which the event identifier of the current event matches with the event identifier in the program initiation notice from the current/next event information transmission schedule, acquires single-event information of the concerned channel which matches with the event identifier of the current event and the event identifier of the next event and generates current/next event information.

The generated current/next event information is output in place of the currently transmitted current/next event information of the concerned channel. The schedule event information and the current/next event information are transmitted continuously at predetermined time intervals.

The schedule event information and the current/next event information are multiplexed together with program data (images and sounds) by a multiplexing device which is not shown and then transmitted from an uplink device which is not shown.

A receiver which is not shown receives the schedule event information, constructs the program information of each channel from the received schedule event information and displays the program information according to the operation of a viewer. The viewer can select a program to view or record by using the program information.

Further, the receiver receives the current/next event information and constructs the program information of a currently broadcast program and a program to be broadcast subsequently of each channel from the received current/next event information. The viewer can select a program to view or record by using the program information. Further, the receiver can start a programmed recording when the information associated with the program selected to be recorded by the viewer appears in the current event information and stops the programmed recording when the information associated with the program disappears from the current/next event information.

Representative examples of the above schedule event information and the current/next event information are those standardized by DVB/SI standard (EST300 468 Digital Broadcasting Systems for television, sound and data services; Specification for Service Information (SI) in Digital Video Broadcasting (DVB) systems (1998-2)) and ARIB (aggregate corporation, radio wave industrial world) standard “ARIB STD-B10” (designed on Jun. 19, 1997).

However, the conventional program guide information-generating/transmitting system has the following problems.

In simultaneous broadcasting, programs to be broadcast on one channel are also broadcast on other channel. In this case, the editor of a program broadcasting schedule registers the same contents as those of the program broadcasting schedule of a simulcast original channel in the program broadcasting schedule of a simulcast secondary channel in relation to a simultaneous broadcasting range by means of the program editing device 101.

However, in this system, when the program broadcasting schedule of the simulcast original channel is to be edited, the program broadcasting schedule of the simulcast secondary channel must also be edited in the same way, thereby causing an editor to repeat the same editing process twice and make mistakes during editing the schedule.

### DISCLOSURE OF THE INVENTION

An object of the present invention is to provide a program information-generating device and a program guide information-transmitting device which still can generate and transmit proper program guide information even when an efficient editing method is applied to program broadcasting schedules in simultaneous broadcasting for overcoming the above problems; and a system which has attained improved efficiency throughout the whole process of generating and transmitting program guide information by the program information-generating device and the program guide information-transmitting device.

To achieve the above object, the program guide information-generating device of the program guide information-generating/transmitting system of the present invention is provided with a simulcast range processing block which generates a program broadcasting schedule by replacing the simulcast range information registered in a program broadcasting schedule with the program entry of the program broadcasting schedule of the corresponding simulcast original channel.

Further, in one embodiment of the present invention, the program guide information-generating device is provided with single-event information for simulcast range generating block that supports all combinations of programs and channels which may possibly be subjected to simultaneous broadcasting and that generates single-event information whose start time is undetermined as single-event information for a simulcast range in advance.

Further, in another embodiment of the present invention, the program guide information-transmitting device is provided with a current/next event information-transmitting block which receives a current/next event information transmission schedule, single-event information and the above single-event information for a simulcast range from the program guide information-generating device and generates and transmits current/next event information by use of the information of the program initiation notice received from the program initiation control device.

Therefore, even in the case where the efficiency in editing is to be increased by a method in which the program broadcasting schedule of a simulcast original channel is used as the program broadcasting schedule of a simulcast secondary channel, the above method is replaced by a method in which the program broadcasting schedule of the simulcast original channel is not used as the program broadcasting schedule of the simulcast secondary channel, thereby making the preparation of program guide information possible.

In addition, for convenience of editing, a method is adopted in which the simulcast range information registered in the program broadcasting schedule is registered with the date and time to start broadcasting undetermined. Thus, even when the above replacement cannot be made, the current/next event information can be transmitted accurately from the program guide information-transmitting device.

### BRIEF DESCRIPTION OF THE DRAWINGS

The above object and characteristics of the present invention will be easily apparent from the embodiments which will be described in detail with reference to the drawings hereinafter.

FIG. 1 is a block diagram showing the constitution of the program guide information-generating/transmitting system in a first embodiment of the present invention.

FIG. 2 is a block diagram showing a conventional program guide information-generating/transmitting system.

FIG. 3 is a diagram showing program information.

FIG. 4 is a diagram showing a program broadcasting schedule.

FIG. 5 is a diagram showing a channel management table.

FIG. 6 is a diagram showing a program broadcasting schedule with a simulcast range.

FIGS. 7A and 7B are portions of a flowchart showing the steps of the simulcast range process of the first embodiment.

FIGS. 8A, 8B and 8C are portions of a flowchart showing the steps of the simulcast range extraction process of the first embodiment.

FIG. 9 is a diagram showing a simulcast range replacement schedule.

FIG. 10 is a diagram showing a program broadcasting schedule after simulcast range replacement.

FIGS. 11A and 11B are portions of a flowchart showing the steps of the schedule event information generation process of the first embodiment.

FIGS. 12A and 12B are portions of a diagram showing schedule event information.

FIGS. 13A and 13B are portions of a flowchart showing the transmission schedule-generating method of the first embodiment.

FIG. 14 is a diagram showing a current/next event information transmission schedule.

FIGS. 15A and 15B are portions of a flowchart showing the single-event information-generating method of the first embodiment.

FIG. 16 is a diagram showing single-event information.

FIGS. 17A and 17B are portions of a flowchart showing the steps of the program initiation notice reception process of the first embodiment.

FIG. 18 is a diagram showing current/next event information.

FIG. 19 is a diagram showing a program initiation notice (without a simulcast original channel identifier).

FIG. 20 is a diagram showing a program initiation notice (with a simulcast original channel identifier).

FIG. 21 is a block diagram showing the constitution of the program guide information generating/transmitting system in a second embodiment of the present invention.

FIGS. 22A and 22B are portions of a flowchart showing the steps of the simulcast range process on an undetermined program broadcasting schedule of the second embodiment.

FIG. 23 is a diagram showing a current/next event information transmission schedule with a simulcast range.

FIG. 24 is a diagram showing a current/next event information transmission schedule without a simulcast range.

FIGS. 25A and 25B are portions of a flowchart showing the method of the second embodiment for generating single-event information for a simulcast range.

FIG. 26 is a diagram showing single-event information for a simulcast range.

FIGS. 27A and 27B are portions of a flowchart showing the steps of the program initiation notice reception process of the second embodiment.

FIG. 28 is a diagram showing an undetermined program broadcasting schedule.

FIG. 29 is a diagram showing a program broadcasting schedule with a simulcast range.

FIG. 30 is a diagram showing a program initiation notice with a management code.

### BEST MODE FOR CARRYING OUT THE INVENTION

(First Embodiment)

In this program guide information-generating/ transmitting system, even in the case where the efficiency in editing is to be increased by a method in which the program broadcasting schedule of a simulcast original channel is used for the program broadcasting schedule of a simulcast secondary channel, the program events of the program broadcasting schedule of the simulcast original channel are replaced so that the program broadcasting schedule of the simulcast original channel is not used for the program broadcasting schedule of the simulcast secondary channel.

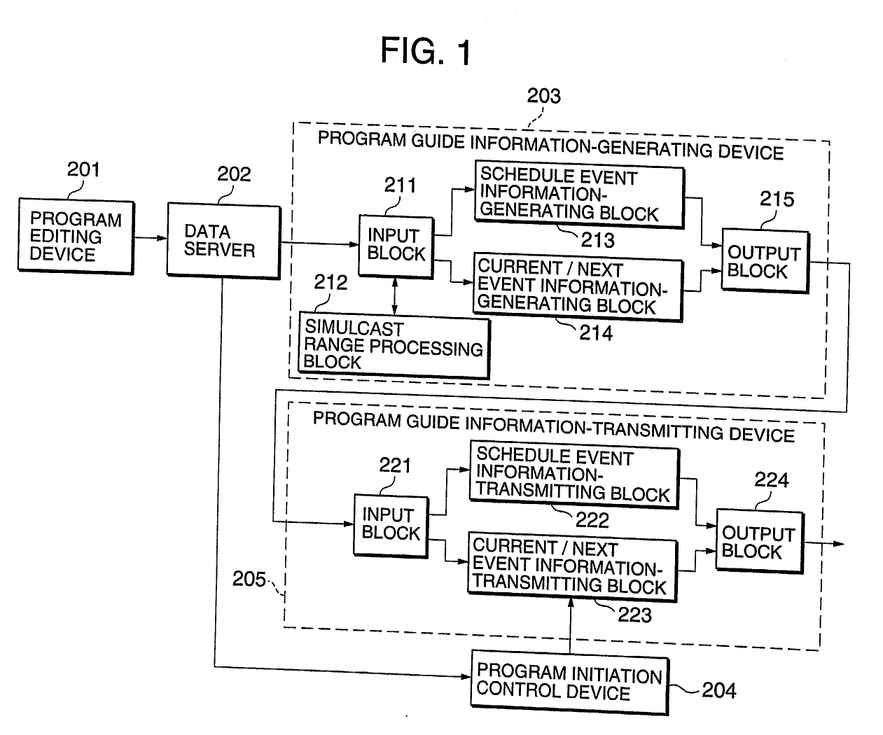

This program guide information-generating/transmitting system, as shown in FIG. 1, comprises a program editing device 201 which edits the program broadcasting schedule of each channel and program information, a data server 202 which manages the information edited by the program editing device 201, a program guide information-generating device 203 which generates program guide information (schedule event information, single-event information and current/next event information transmission schedule), a program initiation control device 204 which follows the program schedule edited by the program editing device 201 and transmits a program initiation notice by means of an external trigger, and a program guide information-transmitting device 205 which transmits the schedule event information and the current/next event information.

The program guide information-generating device 203 comprises an input block 211 which receives a program broadcasting schedule and program information from the data server 202, a simultaneous broadcasting range processing block 212 which receives a program broadcasting schedule from the input block 211, replaces a simultaneous broadcasting range registered in the program broadcasting schedule with the concerned schedule portion of the program broadcasting schedule of a simultaneous broadcasting original channel and transmits the resulting program broadcasting schedule, a schedule event information-generating block 213 which receives the program broadcasting schedule and the program information from the input block 211 and generates schedule event information and a schedule event information transmission schedule, a current/next event information-generating block 214 which receives the program broadcasting information and the program information from the input block 211 and generates single-event information and a current/next event information transmission schedule, and an output block 215 which outputs the schedule event information, single-event information and current/next event information transmission schedule received from the schedule event information-generating block 213 and the current/next event information-generating block 214.

Further, the program guide information-transmitting device 205 comprises an input block 221 which receives the schedule event information, the single-event information and the current/next event information transmission schedule from the program guide information-generating device 203, a schedule event information-transmitting block 222 which receives the schedule event information from the input block 221 and outputs the newly received schedule event information in place of the schedule event information which is currently transmitted on each channel, a current/next event information-transmitting block 223 which receives the single-event information and the current/next event information transmission schedule from the input block 221, generates current/next event information from the single-event information and the current/next event information transmission schedule in accordance with the program initiation notice transmitted from the program initiation control device 204 and transmits the current/next event information, and an output block 224 which receives the schedule event information and the current/next event information and outputs them at predetermined intervals.

A description will be given to the operation of this program guide information-generating/transmitting system.

The program editing device 201 has the function of editing and registering program information and the program broadcasting schedule of each channel by the operation of a manager.

The program information in the present embodiment can be identified uniquely by a event identifier, and the program broadcasting schedule of each channel in the present embodiment can be identified uniquely by a channel identifier. Further, the program broadcasting schedule and the program information can be associated with each other by the event identifier.

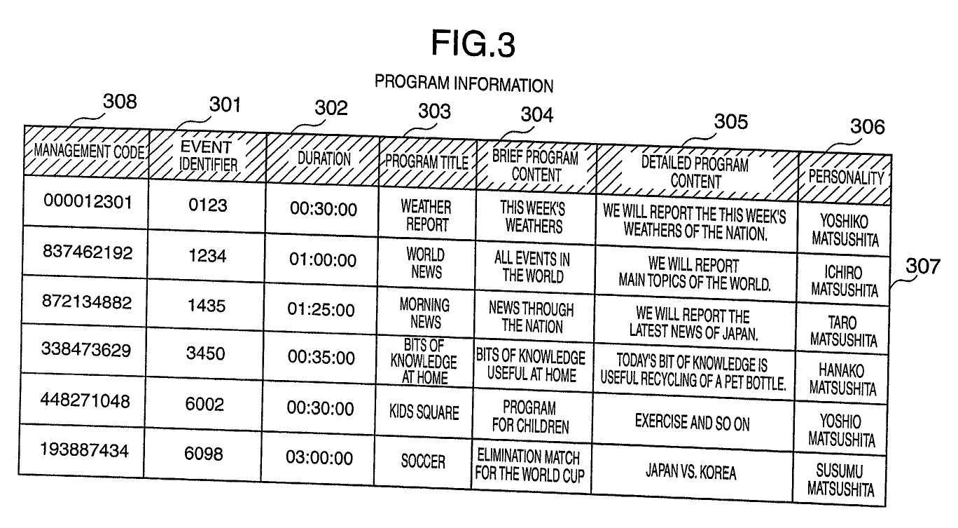

An example of the program information is shown in FIG. 3. In the program information, a program information entry comprising, for example, a event identifier 301, a duration 302, a program title 303, a brief program content 304, a detailed program content 305, a personality 306 and a management code 308 is registered. For example, in a program information entry 307, “1234” is registered as the event identifier, “01:00:00” as the duration, “world news” as the program title, “all events and accidents in the world” as the brief program content, “We will report major topics of the world.” as the detailed program content and “Ichiro Matsushita” as the personality.

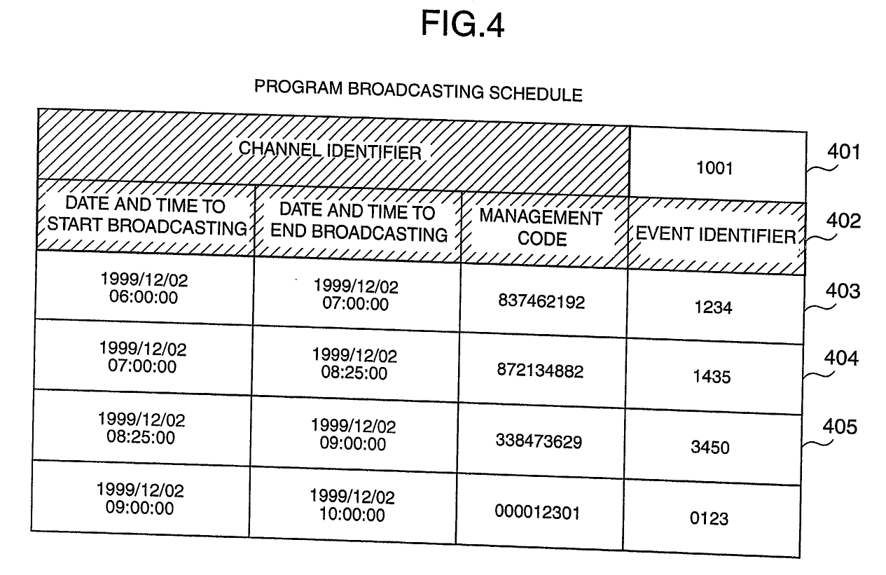

An example of the program broadcasting schedule is shown in FIG. 4. The program broadcasting schedule is edited for each channel. For example, it is understood from 401 that the program broadcasting schedule of FIG. 4 is the schedule of a channel 1001. In the program broadcasting schedule, as shown in 402, a program entry comprising, for example, a date and time to start broadcasting, a date and time to end broadcasting, a management code and a event identifier is described for each of the programs belonging to the channel, and the program entries are scheduled in the order they are broadcast. For example, in the first program entry of this program broadcasting schedule, “1999/12/02 06:00:00” is registered as the date and time to start broadcasting, “1999/12/02 07:00:00” as the date and time to end broadcasting, “837462192” as the management code and “1234” as the event identifier.

The program editing device 210, as shown in FIG. 3, can register program information can register program information associated with a plurality of programs. Further, the program editing device 210 can prepare a program schedule for each channel and register the program in the program information in the program broadcasting schedule. The same programs registered in the program information and the program schedule are associated with each other by a event identifier.

For example, as shown in FIGS. 3 and 4, a program information entry in the program information comprising “1234” as a event identifier, “01:00:00” as a duration, “world news” as a program title, “all events and accidents in the world” as a brief program content, “We will report major topics of the world.” as a detailed program content and “Ichiro Matsushita” as a personality is associated with a program entry in the program entry comprising “1999/12/02 06:00:00” as a date and time to start broadcasting, “1999/12/02 07:00:00” as a date and time to end broadcasting and “1234” as a event identifier.

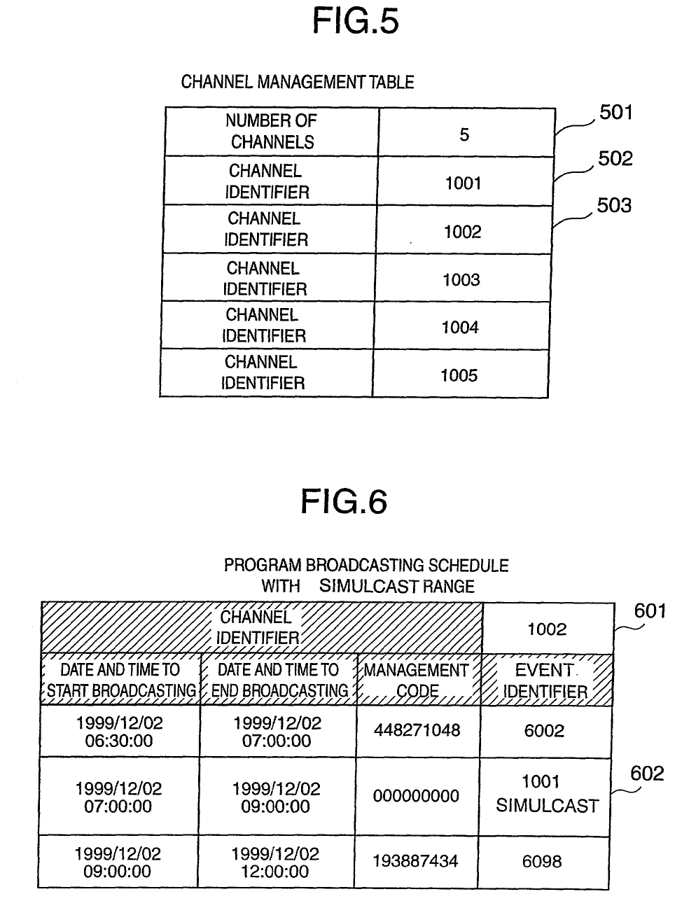

The program editing device 201 retains a channel management table and can edit a plurality of program broadcasting schedules having the channel identifiers registered in the above channel management table. Further, the program editing device 201 can set a simultaneous broadcasting range in the program broadcasting schedule. For example, when the program editing device 201 retains the channel management table shown in FIG. 5, the program editing device 201 can edit the program broadcasting schedules of the five channels identified by the channel identifiers “1001” to “1005”. Then, for example, when the programs between the start time “1999/12/02 07:00:00” and the end time “1999/12/02 09:00:00” on the channel identifier “1001” are simultaneous-broadcast on the channel identifier “1002”, the simultaneous broadcasting range can be registered as a “1001 simultaneous” 602 as shown in FIG. 6. In the simultaneous broadcasting range 602, the event identifier “1435”404 and the event identifier “3450”450 in the program broadcasting schedule with the channel identifier “1001” shown in FIG. 4.

The program editing device 201 outputs the program broadcasting schedules of all channels and all registered program information to the data server 202.

The data server 202 manages all the received program broadcasting schedules of all channels and program information and outputs the program broadcasting schedules and program information registered by the program editing device 201 to the program guide information-generating device 203 either periodically or in accordance with an external trigger or the demand from the program guide information-generating device 203. For example, the program guide information-generating device 203 makes a demand for acquiring the program broadcasting schedules and the program information to the data server 202 once in a day.

The program guide information-generating device 203 receives the program broadcasting schedules and program information output from the data server by means of the input block 211. The input block 211 outputs the received program broadcasting schedules to the simultaneous broadcasting range processing block 212, receives the program broadcasting schedules processed by the simultaneous broadcasting range processing block 212, and then outputs the program broadcasting schedules and the program information to the schedule event information-generating block 213 and the current/next event information-generating block 214.

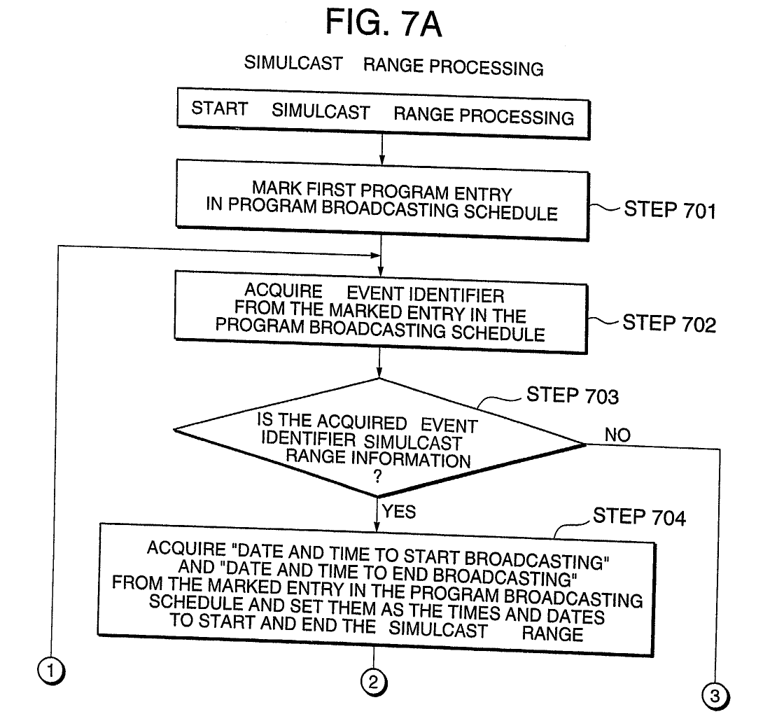

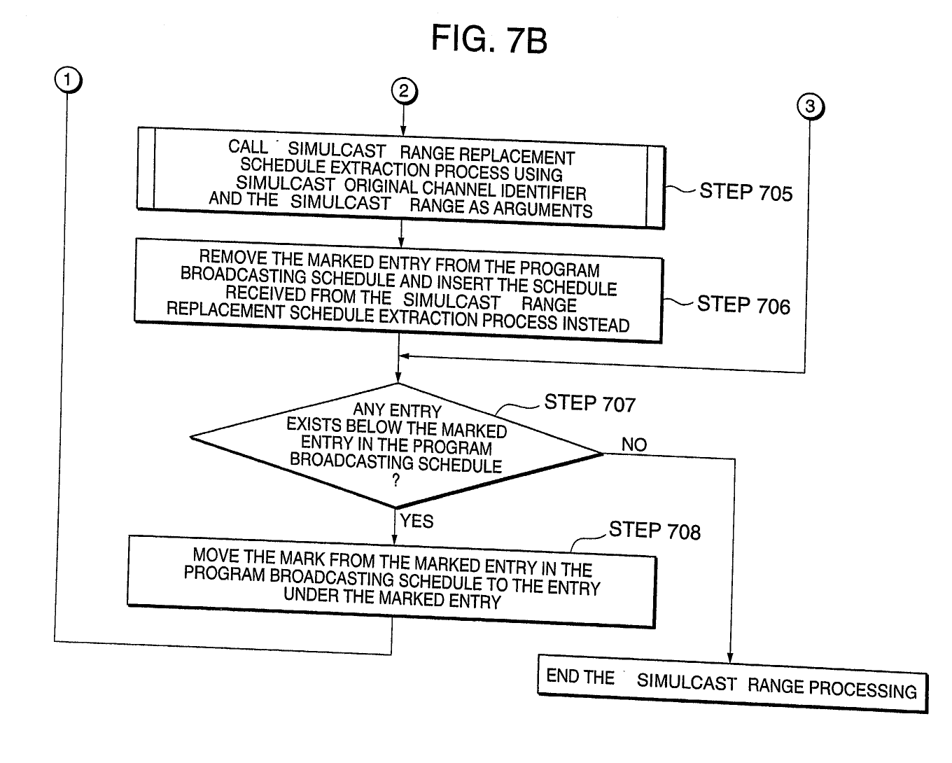

When the simultaneous broadcasting range processing block 212 receives the program broadcasting schedules from the input block 211 and simultaneous broadcasting ranges are registered in the program broadcasting schedules, the simultaneous broadcasting range processing block 212 performs a simulcast range process on all of the received program broadcasting schedules, that is, replaces the simultaneous broadcasting ranges with the concerned schedule portions of the program broadcasting schedules of simultaneous broadcasting original channels. The simulcast range process will be described with reference to FIG. 7.

Step 701: Mark the first program entry in a program broadcasting schedule.

Step 702: Acquire a event identifier from the marked program entry in the program broadcasting schedule.

Step 703: Check whether the acquired event identifier is simulcast range information.

Step 704: When the acquired event identifier is found to be simulcast range information in the step 703, acquire “date and time to start broadcasting” and “date and time to end broadcasting” from the marked program entry in the program broadcasting schedule and use them as the times and dates to start and end the simulcast range.

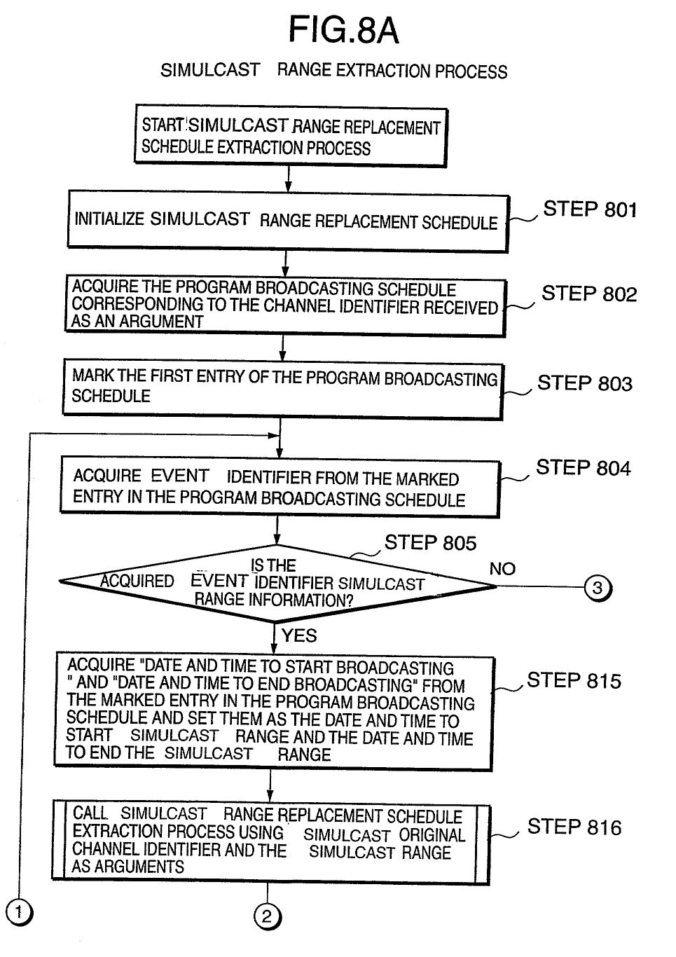

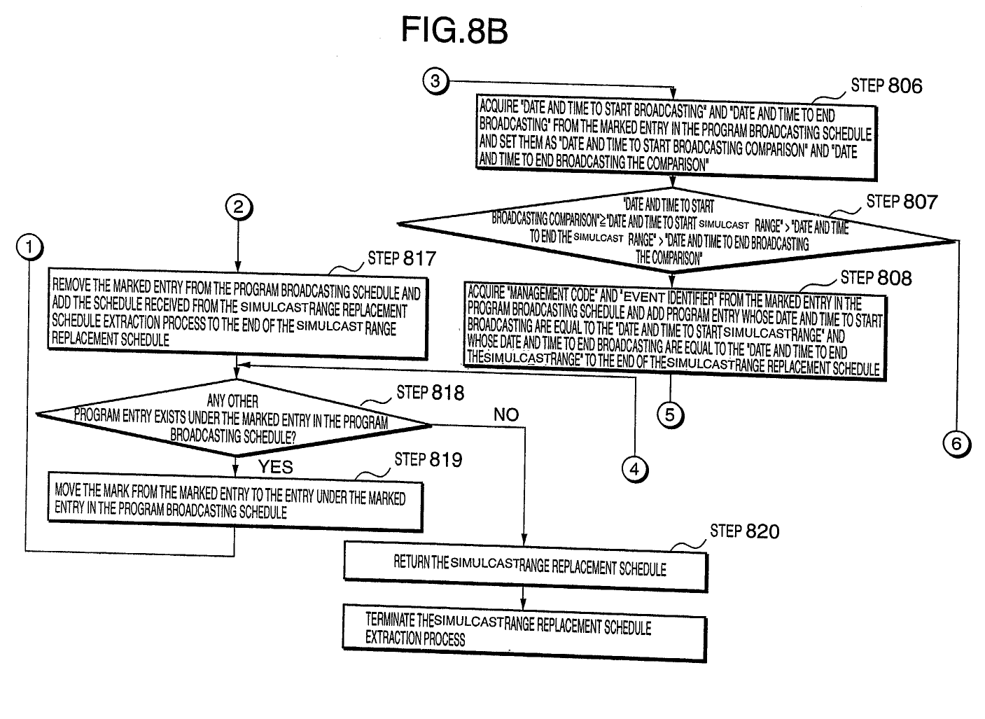

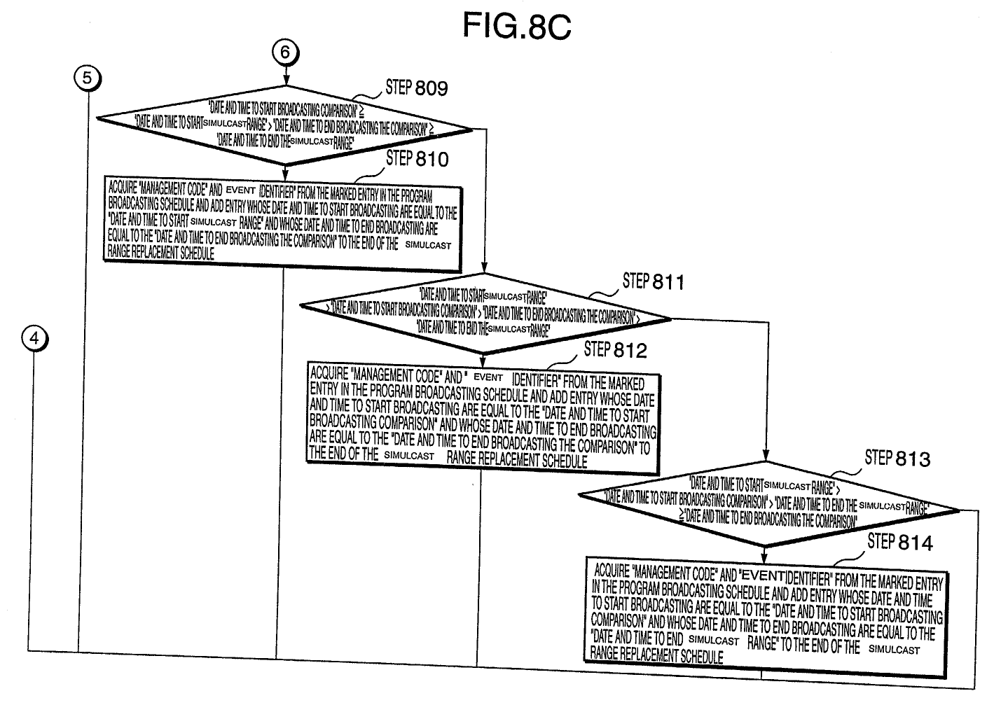

Step 705: Call a simulcast range replacement schedule extraction process (that is, a process in which the replacement schedule of the simulcast range is extracted from the program broadcasting schedule of a simultaneous broadcasting original channel) using a simulcast original channel identifier and the simulcast range as arguments (the process will be described in FIG. 8).

Step 706: Receive the simulcast range replacement schedule from the simulcast range replacement schedule extraction process called in the step 705, remove the marked program entry in the program broadcasting schedule, and insert the simulcast range replacement schedule instead.

Step 707: After the processing of the step 706 or when the event identifier acquired in the step 703 was not simulcast range information, Check whether there is any program entry below the marked program entry in the program broadcasting schedule.

Step 708: When there is other entry in the step 707, mark the program entry under the marked program entry in the program broadcasting schedule and go back to the step 702.

When there is no other entry in the step 707, the simulcast range process is terminated.

Next, the simulcast range replacement schedule extraction process called in the above step 705 will be described with reference to FIG. 8.

Step 801: Perform the initialization of a simulcast range replacement schedule.

Step 802: Acquire the program broadcasting schedule of the channel corresponding to the simulcast original channel identifier received as the argument.

Step 803: Mark the first program entry of the program broadcasting schedule acquired in the step 802.

Step 804: Acquire a event identifier from the marked program entry in the program broadcasting schedule.

Step 805: Check whether the acquired event identifier is simulcast range information.

Step 806: When the event identifier acquired in the step 805 is not simulcast range information, acquire “date and time to start broadcasting” and “date and time to end broadcasting” from the marked program entry in the program broadcasting schedule and use them as “date and time to start broadcasting of a comparison” and “date and time to end broadcasting of the comparison” in the following process.

Step 807: Check whether the date and time to start broadcasting of a comparison and the date and time to end broadcasting of the comparison satisfy a comparison expression 1 (“date and time to start broadcasting of a comparison”≧“date and time to start a simulcast range”>“date and time to end the simulcast range”>“date and time to end broadcasting of the comparison”).

Step 808: when the date and time to start broadcasting of a comparison and the date and time to end broadcasting of the comparison satisfied the comparison expression 1 in the step 807, acquire a “management code” and a “event identifier” from the marked program entry in the program broadcasting schedule, add a program entry whose date and time to start broadcasting are equal to the “date and time to start a simulcast range” and whose date and time to end broadcasting are equal to the “date and time to end the simulcast range” to the end of the simulcast range replacement schedule, and go to a step 818. Step 809: when the date and time to start broadcasting of a comparison and the date and time to end broadcasting of the comparison failed to satisfy the comparison expression 1 in the step 807, check whether the date and time to start broadcasting of a comparison and the date and time to end broadcasting of the comparison satisfy a comparison expression 2 (“date and time to start broadcasting of a comparison”≧“date and time to start a simulcast range”>“date and time to end broadcasting of the comparison”≧“date and time to end the simulcast range”).

Step 810: when the date and time to start broadcasting of a comparison and the date and time to end broadcasting of the comparison satisfied the comparison expression 2 in the step 809, acquire a “management code” and a “event identifier” from the marked program entry in the program broadcasting schedule, add a program entry whose date and time to start broadcasting are equal to the “date and time to start a simulcast range” and whose date and time to end broadcasting are equal to the “date and time to end broadcasting of the comparison” to the end of the simulcast range replacement schedule, and go to the step 818. Step 811: when the date and time to start broadcasting of a comparison and the date and time to end broadcasting of the comparison failed to satisfy the comparison expression 2 in the step 809, check whether the date and time to start broadcasting of a comparison and the date and time to end broadcasting of the comparison satisfy a comparison expression 3 (“date and time to start a simulcast range”>“date and time to start broadcasting of a comparison”>“date and time to end broadcasting of the comparison”>“date and time to end the simulcast range”).

Step 812: when the date and time to start broadcasting of a comparison and the date and time to end broadcasting of the comparison satisfied the comparison expression 3 in the step 811, acquire a “management code” and a “event identifier” from the marked program entry in the program broadcasting schedule, add a program entry whose date and time to start broadcasting are equal to the “date and time to start broadcasting of a comparison” and whose date and time to end broadcasting are equal to the “date and time to end broadcasting of the comparison” to the end of the simulcast range replacement schedule, and go to the step 818. Step 813: when the date and time to start broadcasting of a comparison and the date and time to end broadcasting of the comparison failed to satisfy the comparison expression 3 in the step 811, check whether the date and time to start broadcasting of a comparison and the date and time to end broadcasting of the comparison satisfy a comparison expression 4 (“date and time to start a simulcast range”>“date and time to start broadcasting of a comparison”>“date and time to end the simulcast range”≧“date and time to end broadcasting of the comparison”).

Step 814: when the date and time to start broadcasting of a comparison and the date and time to end broadcasting of the comparison satisfied the comparison expression 4 in the step 813, acquire a “management code” and a “event identifier” from the marked program entry in the program broadcasting schedule, add a program entry whose date and time to start broadcasting are equal to the “date and time to start broadcasting of a comparison” and whose date and time to end broadcasting are equal to the “date and time to end the simulcast range” to the end of the simulcast range replacement schedule, and go to the step 818. Further, when the comparison expression 4 was not satisfied in the step 813, go to the step 818.

Step 815: When the event identifier acquired in the step 805 is simulcast range information, acquire a “date and time to start broadcasting” and a “date and time to end broadcasting” from the marked program entry in the program broadcasting schedule and use them as the date and time to start a simulcast range and the date and time to end the simulcast range.

Step 816: Call the simulcast range replacement schedule extraction process using the simulcast original channel identifier and simulcast range acquired in the step 815 as arguments.

Step 817: Receive a simulcast range replacement schedule from the simulcast range replacement schedule extraction process and add it to the end of the simulcast range replacement schedule which is being prepared by the process.

Step 818: Check whether there is any other program entry under the marked program entry in the program broadcasting schedule.

Step 819: When there is other program entry in the step 818, mark the program entry under the marked program entry in the program broadcasting schedule. Step 820: When there is not other program entry in the step 818, returns the generated simulcast range replacement schedule and terminates the simulcast range replacement schedule extraction process.

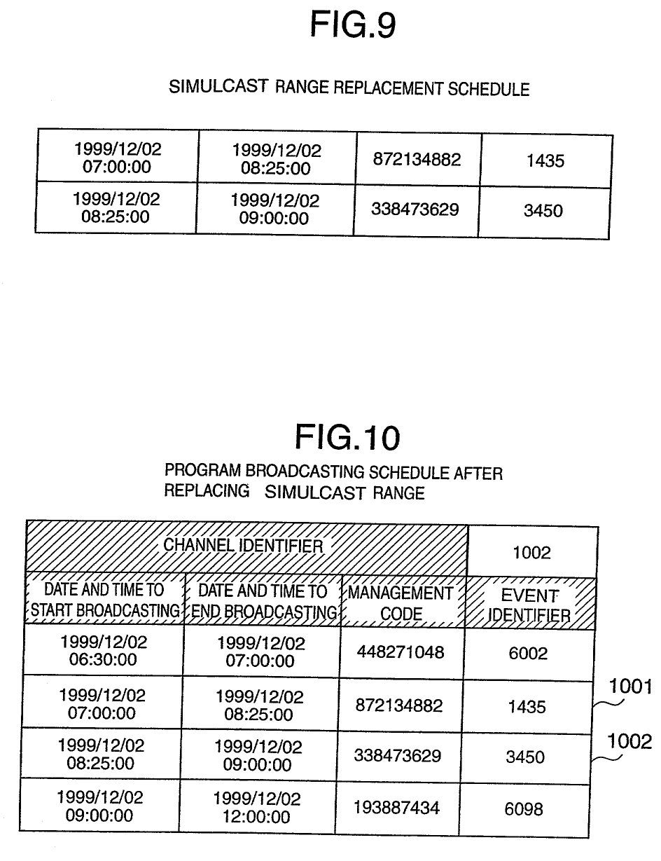

The thus-generated program broadcasting schedule after the simulcast range replacement is shown in FIG. 10. FIG. 10 is the program broadcasting schedule of a channel identifier 1002 which is obtained by replacing the program broadcasting schedule of FIG. 6 with the program broadcasting schedule of the channel identifier 1001 shown in FIG. 4. When the simulcast range processing block 212 finds the simulcast range 602 in the program broadcasting schedule of FIG. 6 by means of the simulcast range process, the simulcast range processing block 212 extracts the simulcast range replacement schedule shown in FIG. 9 from the program broadcasting schedule shown in FIG. 4 by means of the simulcast range replacement schedule extraction process, replaces the simulcast range 602 with the simulcast range replacement schedule and generates the program broadcasting schedule shown in FIG. 10.

After the simulcast range processing block 212 replaces the simulcast ranges in the program broadcasting schedules of all channels, the simulcast range processing block 212 passes the program broadcasting schedules to the input block 211.

After receiving the program broadcasting schedules from the simulcast range processing block 212, the input block 211 outputs the program broadcasting schedules and program information to the schedule event information-generating block 213 and the current/next event information-generating block 214.

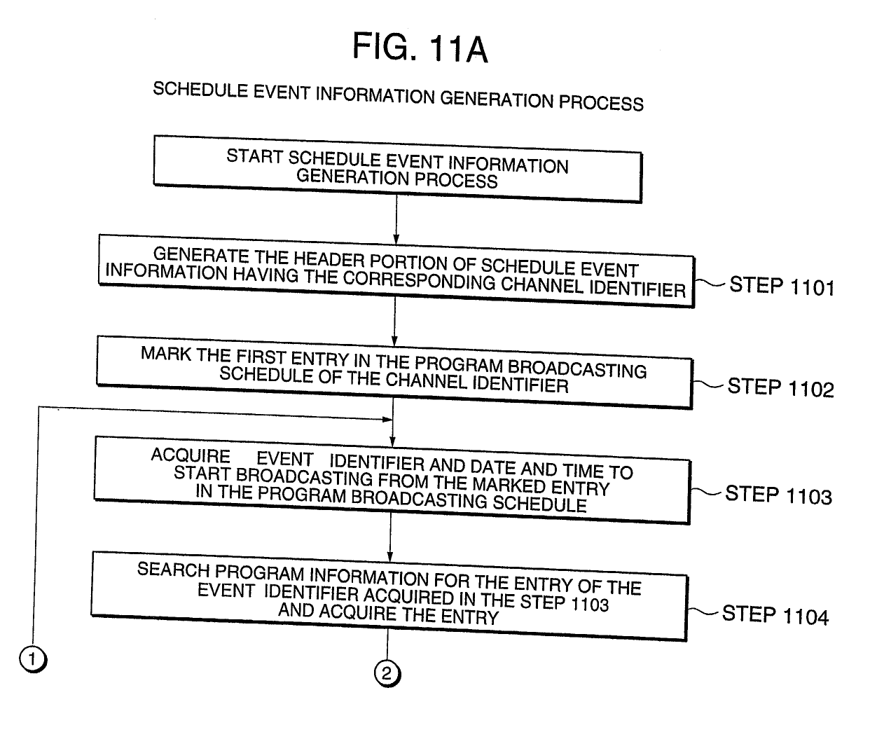

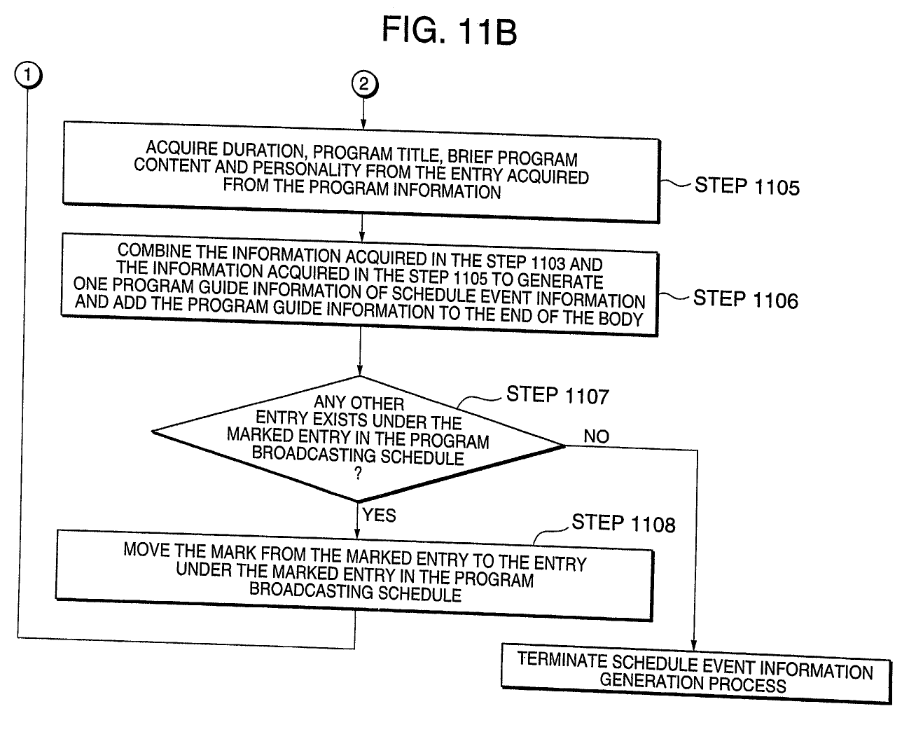

After receiving the program broadcasting schedules and the program information, the schedule event information-generating block 213 generates schedule event information for each of the received program broadcasting schedules. A method for generating the schedule event information will be described with reference to FIG. 11.

Step 1101: Acquire a channel identifier from a program broadcasting schedule and generate the header portion of schedule event information having the channel identifier.

Step 1102: Mark the first program entry of the program broadcasting schedule of the channel identifier.

Step 1103: Acquire a event identifier and a date and time to start broadcasting from the marked program entry in the program broadcasting schedule. For example, acquire a event identifier “1234” 403 and a date and time to start broadcasting “1999/12102 06:00:00” from the program broadcasting schedule of the channel identifier 1001 shown in FIG. 4.

Step 1104: Search the program information for the program entry of the event identifier acquired in the step 1 103 and acquire the program entry. For example, acquire a program entry 307 having a event identifier “1234” from the program information shown in FIG. 3.

Step 1105: Acquire a program duration, a program title, a brief program content and a personality from the program entry acquired in the step 1104. For example, acquire a program duration “01:00:00”, a program title “world news”, a brief program content “all events and accidents in the world” and a personality “Ichiro Matsushita” from the program entry having a event identifier “1234” in the program information shown in FIG. 3.

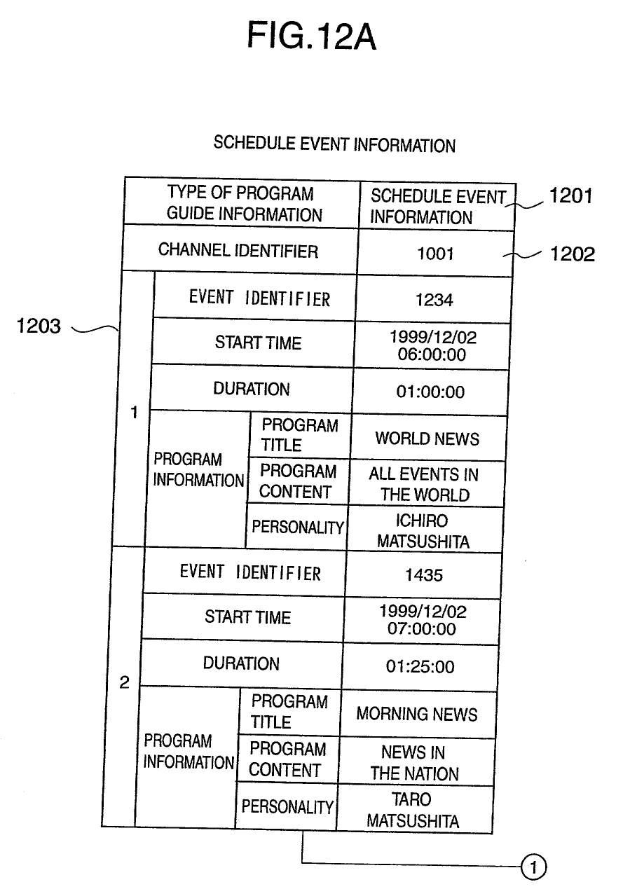

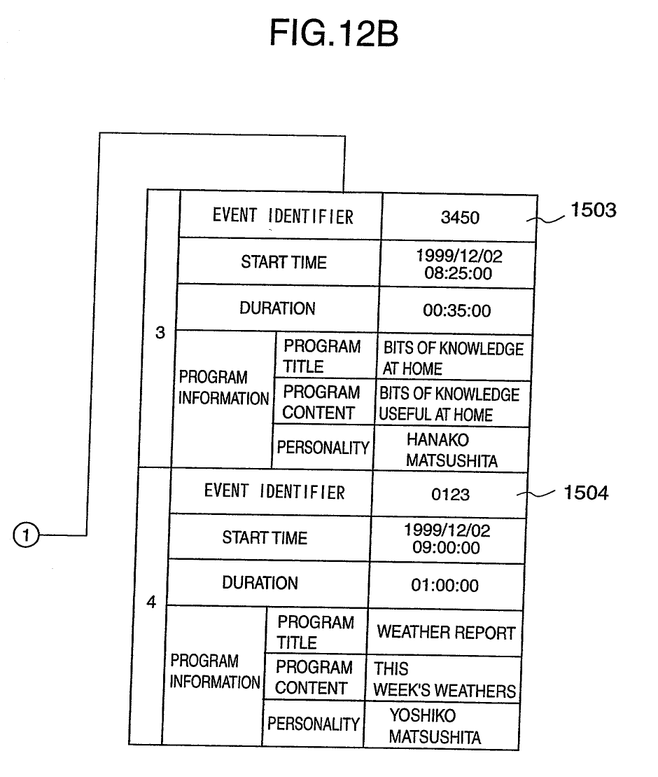

Step 1106: Combine the information acquired in the step 1103 and the information acquired in the step 1105 to generate one program guide information of schedule event information and add the program guide information to the end of the body. For example, generate program guide information 1203 having a event identifier “1234” in the body of the schedule event information shown in FIG. 12.

Step 1107: Check whether there is other program entry under the marked program entry in the program broadcasting schedule.

Step 1108: When there is other program entry in the step 1107, mark the program entry under the marked program entry in the program broadcasting schedule, return to the step 1103 and repeat the subsequent steps. Meanwhile, when there is no other program entry in the step 1107, terminate the schedule event information generation process.

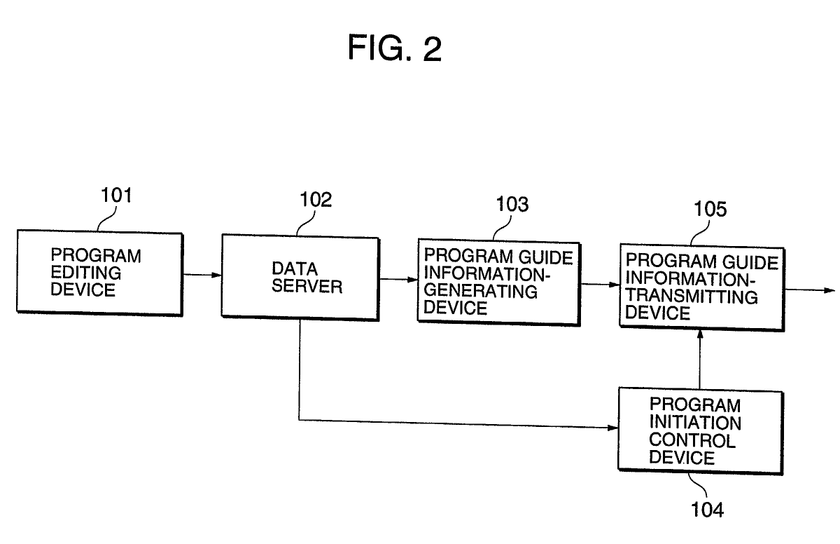

The schedule event information generated from the program broadcasting schedule having the channel identifier 1001 shown in FIG. 4 and the program information of FIG. 3 by the above steps is exemplified in FIG. 2.

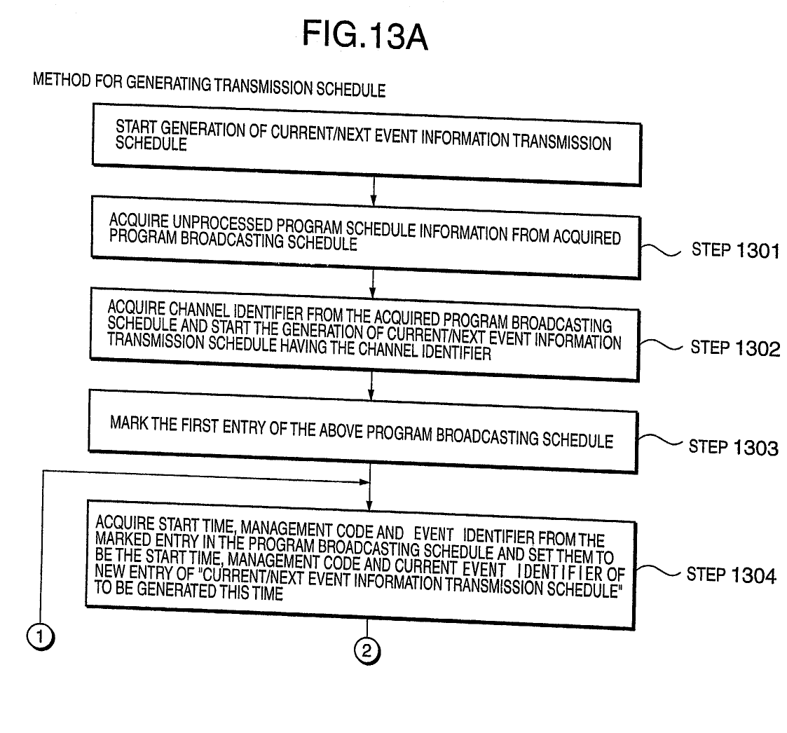

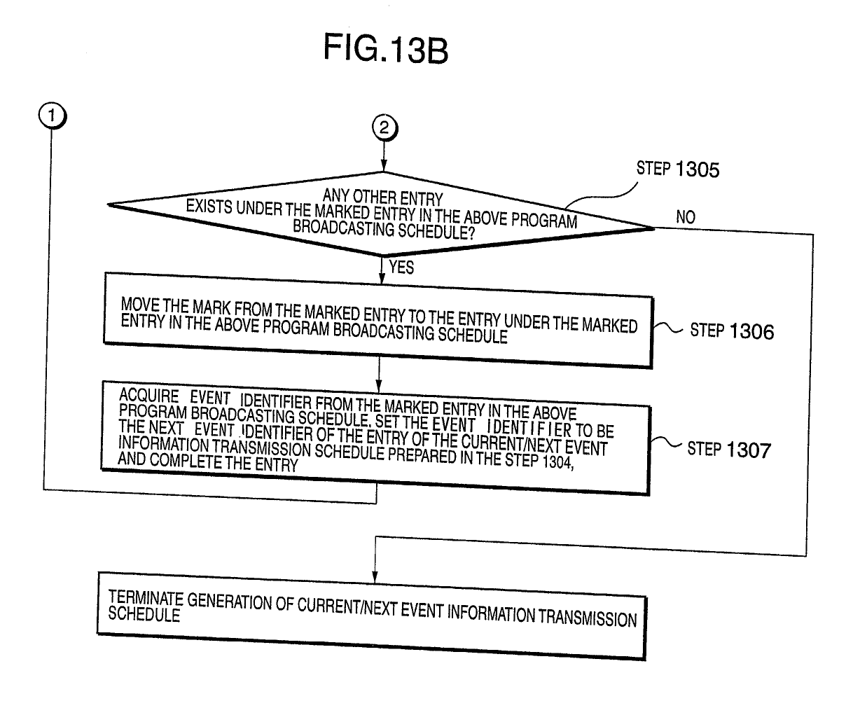

After generating the schedule event information, the schedule event information-generating block 213 outputs the schedule event information to the output block 215. Further, after receiving the program broadcasting schedules and the program information, the current/next event information-generating block 214 generates single-event information and a current/next event information transmission schedule for each of the received program broadcasting schedules. A method for generating the current/next event information transmission schedule will be described with reference to FIG. 13.

Step 1301: The current/next event information-generating block 214 acquires unprocessed program broadcasting schedule information from the acquired program broadcasting schedule,

Step 1302: acquires a channel identifier from the acquired program broadcasting schedule and initiates the generation of a current/next event information transmission schedule having the acquired channel identifier.

Step 1303: Mark the first program entry of the above program broadcasting schedule.

Step 1304: Acquire a start time, a management code and a event identifier from the marked program entry in the program broadcasting schedule and set the start time and the event identifier to be the start time and current event identifier of a new current/next event entry of a “current/next event information transmission schedule” to be generated this time.

Step 1305: Check whether there is any other program entry under the marked program entry in the above program broadcasting schedule. When there is other program entry,

Step 1306: Mark the program entry under the marked program entry in the above program broadcasting schedule.

Step 1307: Acquire a event identifier from the marked program entry in the program broadcasting schedule, set the event identifier to be the next event identifier of the new current/next event entry of the current/next event information transmission schedule prepared in the step 1304, and complete the program entry.

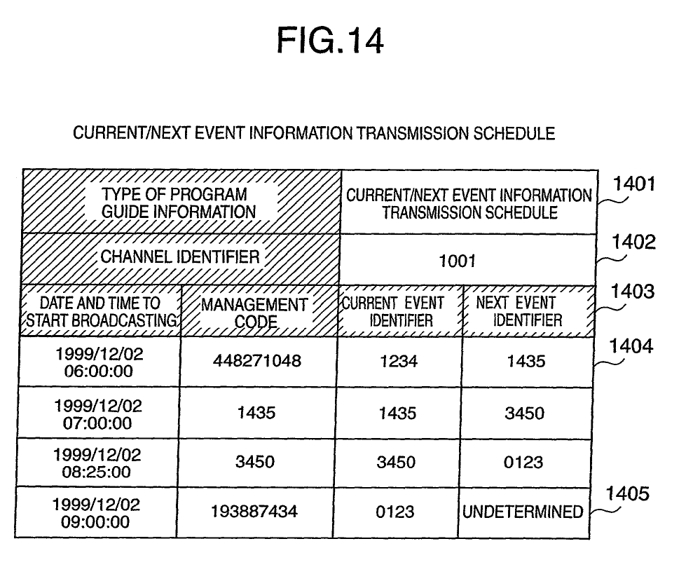

An example of the current/next event information transmission schedule is shown in FIG. 14.

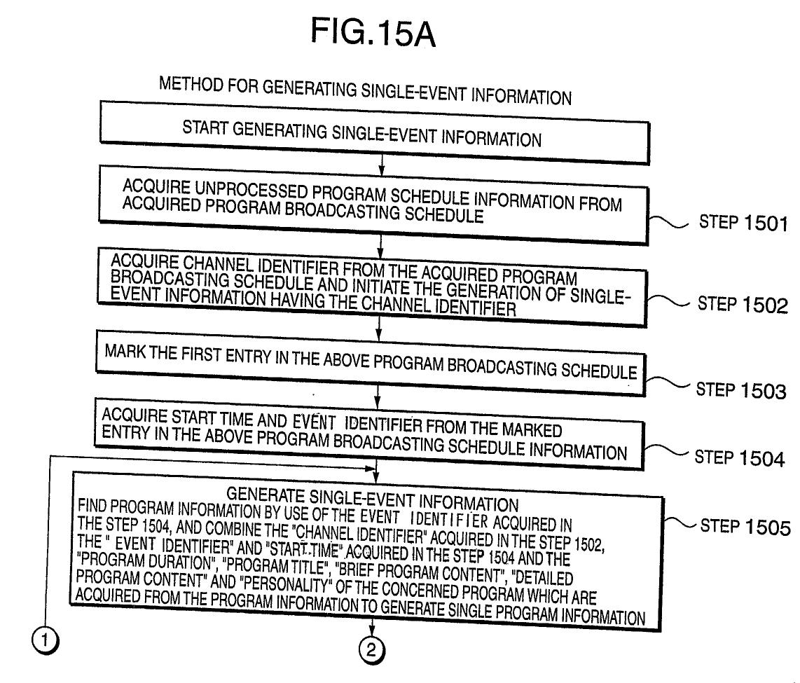

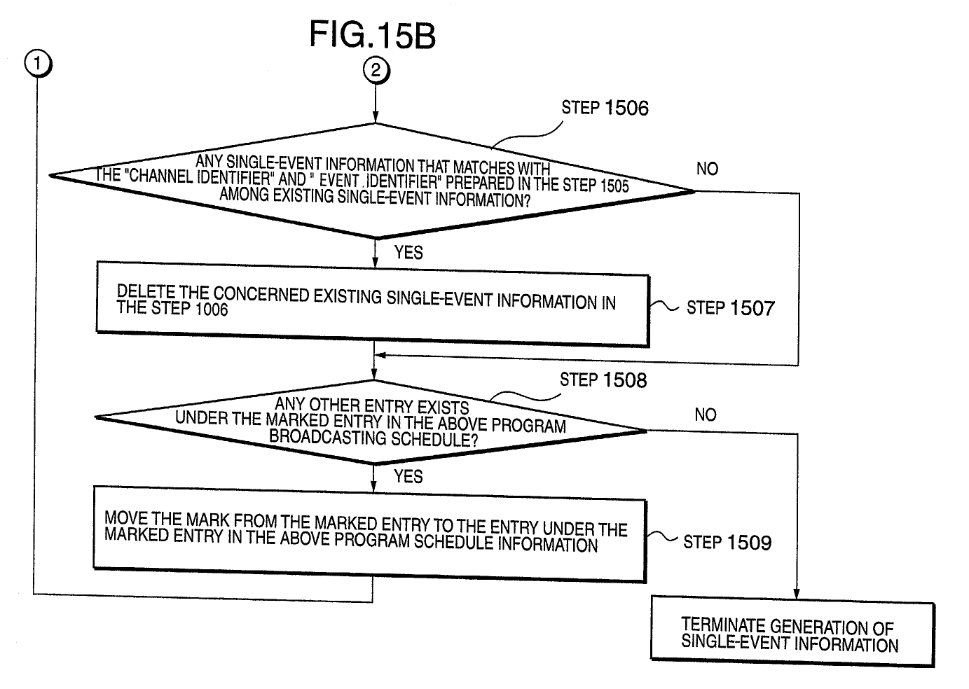

Next, a method for generating single-event information will be described with reference to FIG. 15.

Step 1501: The current/next event information-generating block 214 acquires an unprocessed program schedule from the acquired program broadcasting schedule,

Step 1502: acquires a channel identifier from the program broadcasting schedule and initiates the generation of single-event information having the acquired channel identifier.

Step 1503: Mark the first program entry of the above program broadcasting schedule.

Step 1504: Acquire a start time and a event identifier from the marked program entry in the above program broadcasting schedule.

Step 1505: Find program information by use of the event identifier acquired in the step 1504, and combine the “channel identifier” acquired in the step 1502, the “event identifier” and “start time” acquired in the step 1504 and the “program duration”, “program title”, “brief program content”, “detailed program content” and “personality” of the concerned program which are acquired from the program information to generate single program information.

Step 1506: Check whether there is any single-event information whose channel identfier and event identifier match with the “channel identifier” and “event identifier” prepared in the step 1505 among existing single-event information. When there is such single-event information,

Step 1507: Delete the concerned existing single-event information.

When there is no such single-event information in the step 1506 and after the process of the step 1507,

Step 1508: Check whether there is any other program entry under the marked program entry in the program schedule information. When there is other program entry,

Step 1509: Mark the program entry under the marked program entry in the program schedule information, return to the step 1505 and repeat the subsequent steps.

Meanwhile, when there is no other program entry in the step 1508, terminate the generation of single-event information in relation to the program schedule information.

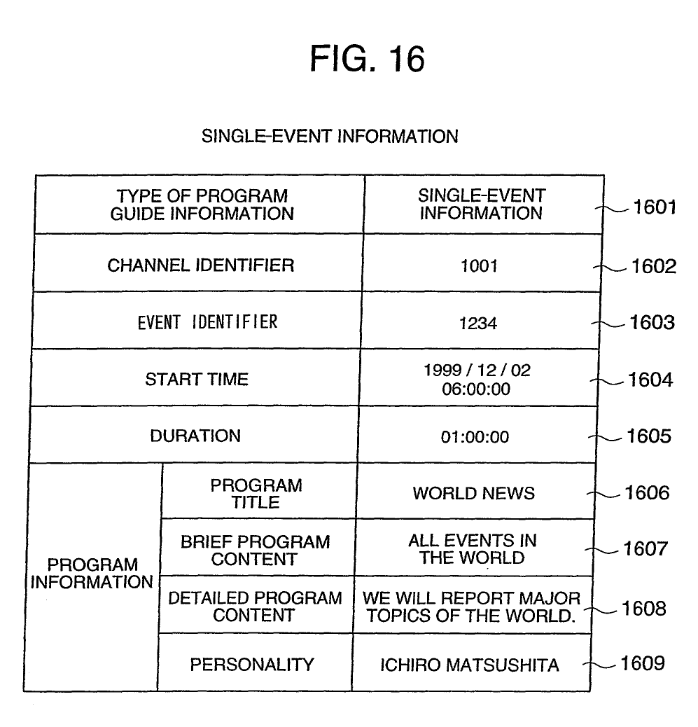

An example of the single-event information is shown in FIG. 16.

The current/next event information-generating block 214 outputs the generated current/next event information transmission schedule and single-event information to the output block 215. The output block 215 outputs the received schedule event information, current/next event information transmission schedule and single-event information to the program guide information-transmitting device 205.

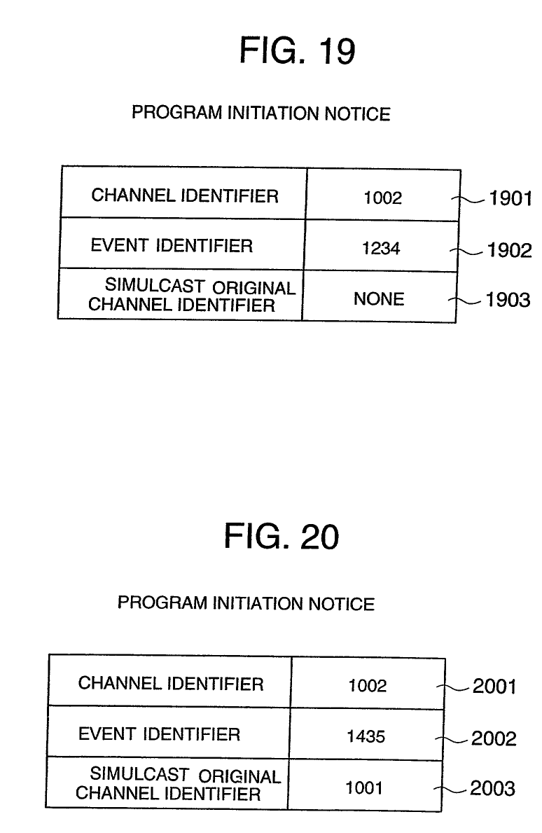

Further, the program initiation control device 204 receives the program broadcasting schedule of each channel from the data server 202 and outputs a program initiation notice each time a program starts in accordance with the program broadcasting schedule. An example of the program initiation notice is shown in FIG. 19. The program initiation notice comprises, for example, a channel identifier 1901, a event identifier 1902 and a simulcast original channel identifier 1903. When a program is not simultaneous-broadcast, the simulcast original channel identifier 1903 contains nothing. When the program broadcasting schedule contains a simulcast range, the program initiation control device 204 outputs a program initiation notice having the same event identifier as that of a program initiation notice to be output to a simulcast original channel during the period of the simulcast range. For example, on the channel identifier “1002” having the program broadcasting schedule of FIG. 6, a program initiation notice to be transmitted on the channel identifier “1001” which is a simulcast original channel is output during the period of “1999/12/02 07:00:00 to 1999/12/02 09:00:00”. For example, at 07:00:00 on 1999/12/02, a program initiation notice shown in FIG. 20 which comprises a channel identifier “1002”, a event identifier “1435” and a simulcast original channel identifier “1001” is output.

After receiving the schedule event information, the current/next event information transmission schedule and the single-event information, the input block 221 of the program guide information-transmitting device 205 outputs the schedule event information to the schedule event information-transmitting block 222 and outputs the current/next event information transmission schedule and the single-event information to the current/next event information-transmitting block 223.

Meanwhile, after receiving the schedule event information, the schedule event information-transmitting block 222 aborts the transmission of the schedule event information which has the channel identifier and which is currently being output from the output block 224 and requests the transmission of the newly received schedule event information having the channel identifier. The schedule event information-transmitting block 222 performs the above process on all the received schedule event information.

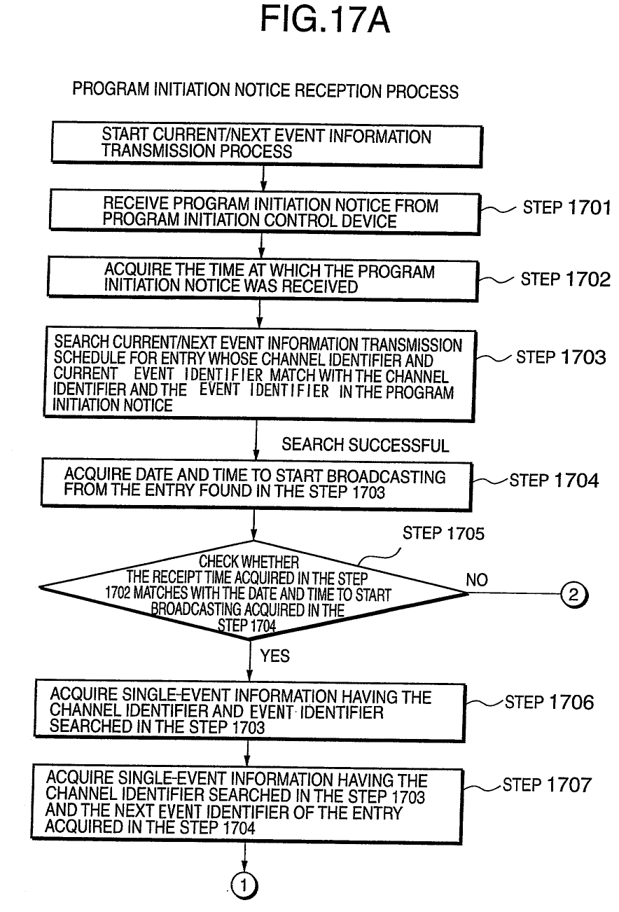

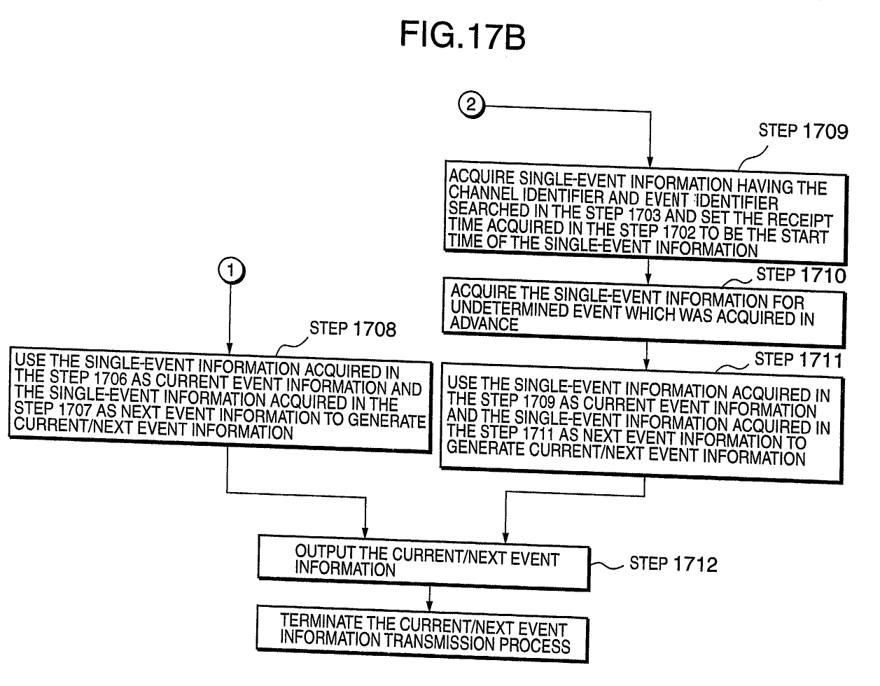

Further, after receiving the current/next event information transmission schedule and the single-event information, the current/next event information-transmitting block 223 generates current/next event information in accordance with the program initiation notice output from the program initiation control device 204 and outputs the current/next event information to the output block 224. The processing method is shown in FIG. 17.

Step 1701: The current/next event information-transmitting block 223 receives a program initiation notice from the program initiation control device 204, and

Step 1702: acquires the time at which it received the program initiation notice.

Step 1703: Search the current/next event information transmission schedule for an entry whose channel identifier and current event identifier match with the channel identifier and the event identifier in the acquired program initiation notice, and

Step 1704: Acquire a date and time to start broadcasting from the found entry.

Step 1705: Checks whether the receipt time acquired in the step 1702 matches with the date and time to start broadcasting acquired in the step 1704. When they match with each other,

Step 1706: Acquire single-event information having the channel identifier and event identifier searched in the step 1703,

Step 1707: Acquire single-event information having the channel identifier searched in the step 1703 and a event identifier subsequent to the event identifier of the entry acquired in the step 1704,

Step 1708: Use the single-event information acquired in the step 1706 as current event information and the single-event information acquired in the step 1707 as next event information to generate current/next event information,

Step 1712: Output the generated current/next event information.

On the other hand, when the receipt time does not match with the date and time to start broadcasting in the step 1705,

Step 1709: Acquire single-event information having the channel identifier and event identifier searched in the step 1703 and set the receipt time acquired in the step 1702 to be the start time of the single-event information,

Step 1710: Acquire the single-event information for an undetermined event which has been acquired in advance,

Step 1711: Use the single-event information acquired in the step 1709 as current event information and the single-event information acquired in the step 1710 as next event information to generate current/next event information,

Step 1712: Output the generated current/next event information.

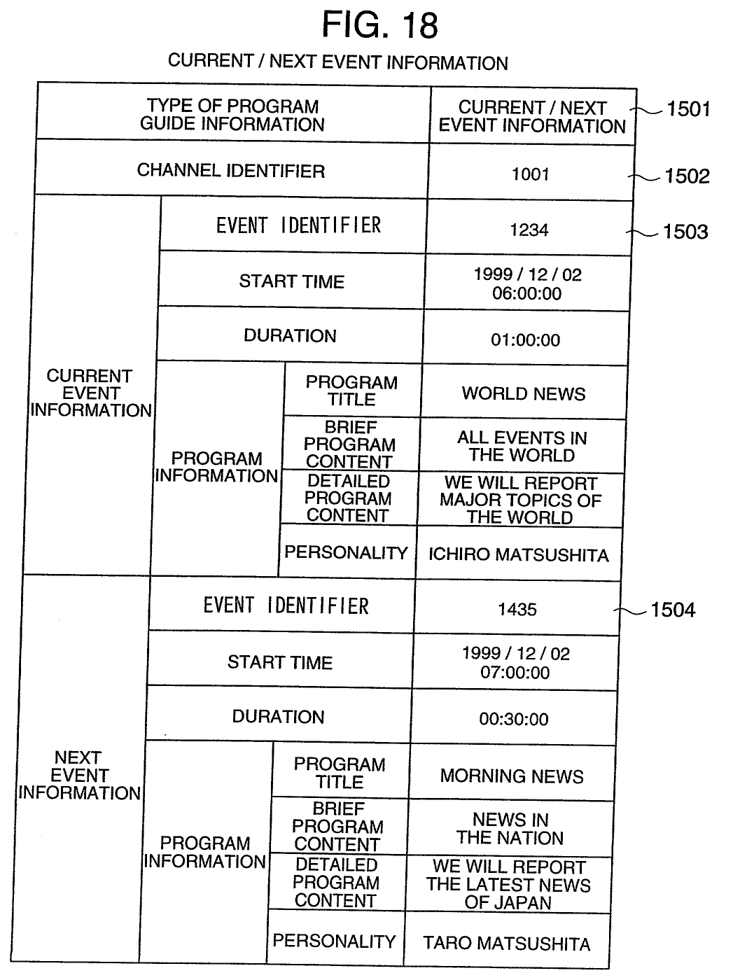

An example of the current/next event information is shown in FIG. 18.

When the current/next event information is output to the output block 224, the output of currently transmitted current/next event information having the concerned channel identifier is aborted, and the transmission of newly generated current/next event information is started.

Following the directions from the schedule event information-transmitting block 222 and the current/next event information-transmitting block 223, the output block 224 aborts the transmission of schedule event information and current/next event information of the concerned channel which are transmitted repeatedly at predetermined time intervals and transmits newly received schedule event information and current/next event information repeatedly at predetermined time intervals.

Further, simulcast range information does not have to be registered in a program entry in the program broadcasting schedule as shown in FIG. 6. As indicated by 3001 in FIG. 29, simulcast range information comprising a simulcast identifier, a simulcast original channel identifier, a date and time to start a simulcast range and a date and time to end the simulcast range can be registered apart from program entries. In the case of the program broadcasting schedule of FIG. 29, the program entries 3002 and 3003 which fall within the simulcast range become invalid and are replaced by the program broadcasting schedule of a simulcast original channel.

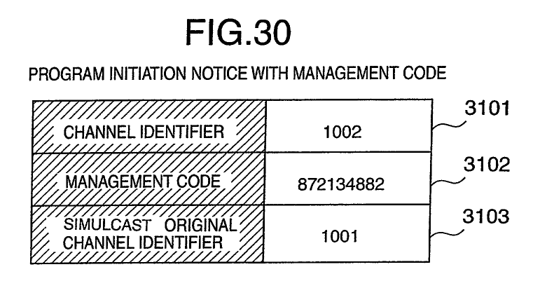

Further, the information included in the program initiation notice may not have to be the “event identifier” indicated by 1902 in FIG. 19 and may be the “management code” indicated by 3102 in FIG. 30. In this case, in the current/next event information transmission process in the current/next event information-transmitting block 223 shown in FIG. 17, when the method (step 1703) of searching the current/next event information transmission schedule is carried out by using the management code in the program initiation notice and the management code in the current/next event entry in place of the event identifier in the program initiation notice and the current event identifier in the current/next event entry, the same effect can still be obtained.

As described above, in this system, when simultaneous broadcasting is carried out between channels, the program editing device 201 registers simulcast range information including a simulcast original channel identifier in the simultaneous broadcasting range on the program broadcasting schedule of a simulcast other channel. Thereby, only the program broadcasting schedule of a simulcast original channel must be edited, thereby saving the time necessary for editing the program broadcasting schedules.

Further, even when the efficient edit is made by the program editing device 201, the program guide information-generating device 203 can generate and transmit program guide information without any problems. This is because when a program broadcasting schedule having simulcast range information registered therein is received, the portion of the program broadcasting schedule of a simulcast original channel which falls within a simulcast range is extracted and the simulcast range is replaced by the extracted schedule portion.

Therefore, simultaneous broadcasting can be managed efficiently in the system as a whole.

(Second Embodiment)

The program guide information-generating/transmitting system of the second embodiment adopts, for convenience in editing a program broadcasting schedule, a technique of registering an undetermined simulcast range or registering a simulcast range in the program broadcasting schedule of a simulcast original channel with its date and time to start broadcasting undetermined. Therefore, the program guide information-generating/transmitting system still can generate and transmit current/next event information accurately even when the simulcast range cannot be replaced (consequently, schedule event information cannot be prepared).

Therefore, to allow any program(s) to be broadcast in the simulcast range, the program guide information-generating/transmitting system generates single-event information (single-event information for a simulcast range) whose start time is “undetermined” in advance, specifies single-event information for a simulcast range to be used based on the channel identifier, event identifier and simulcast channel identifier contained in a program initiation notice when receiving the program initiation notice, generates and transmits current/next event information with the reception time of the program initiation notice set to be the start time.

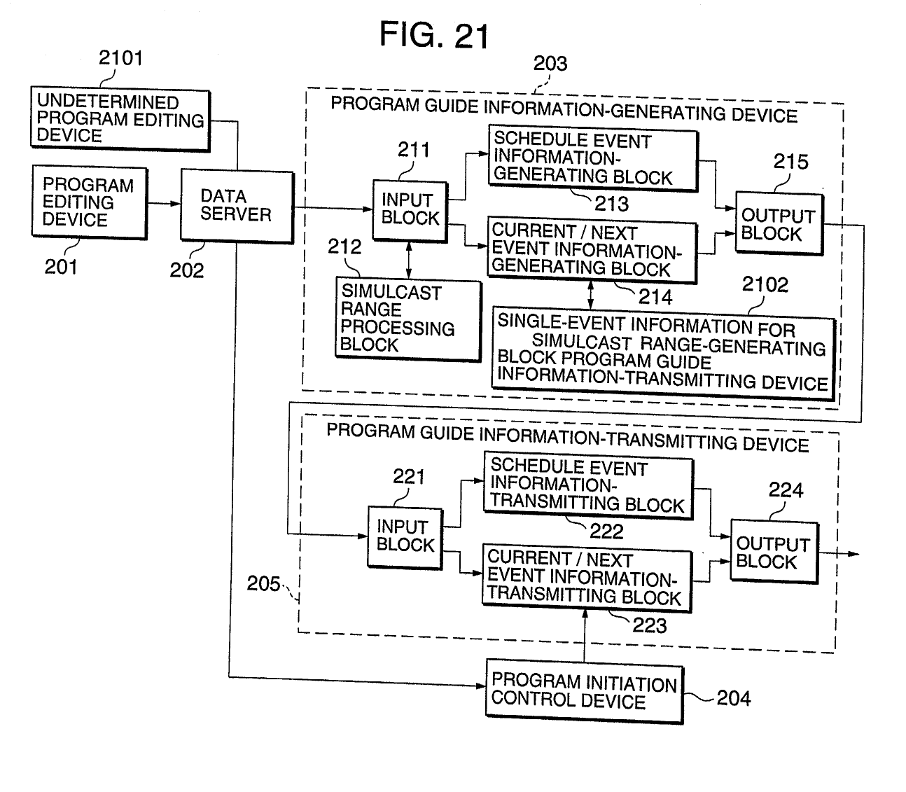

This program guide information-generating/transmitting system, as shown in FIG. 21, comprises a program editing device 201 which edits the program broadcasting schedule of each channel and program information, an undetermined program editing device 2101 which makes edits with the time to start broadcasting on each channel undetermined, a data server 202 which manages the information edited by the program editing device 201 and the undetermined program editing device 2101, a program guide information-generating device 203 which outputs schedule event information, single-event information and current/next event information transmission schedule, a program guide information-transmitting device 205 which transmits the schedule event information and the current/next event information, and a program initiation control device 204 which follows the program schedule edited by the program editing device 201 and transmits a program initiation notice by an external trigger.

Further, the program guide information-generating device 203 comprises an input block 211 which receives a program broadcasting schedule and program information from the data server 202, a simultaneous broadcasting range processing block 212 which receives a program broadcasting schedule from the input block 211, when a simultaneous broadcasting range is registered in the program broadcasting schedule and is replaceable, replaces the simultaneous broadcasting range with the corresponding schedule range of the program broadcasting schedule of a simultaneous broadcasting original channel and outputs the resulting program broadcasting schedule, a schedule event information-generating block 213 which receives a program broadcasting schedule and program information from the input block 211 and generates schedule event information and a schedule event information transmission schedule, a current/next event information-generating block 214 which receives a program broadcasting schedule and program information from the input block 211 and generates single-event information and a current/next event information transmission schedule, single-event information for a simulcast range-generating block 2102 which generates single-event information for a simulcast range from the program broadcasting schedule of a simultaneous broadcasting original channel and program information when the program broadcasting schedule which is being processed in the current/next event information-generating block 214 contains unreplaced simulcast range information, and an output block 215 which outputs the schedule event information, single-event information and current/next event information transmission schedule received from the schedule event information-generating block 213 and the current/next event information-generating block 214.

The constitution of the program guide information-transmitting device 205 is the same as that of the first embodiment.

A description will be given to the operation of this program guide information-generating/transmitting system.

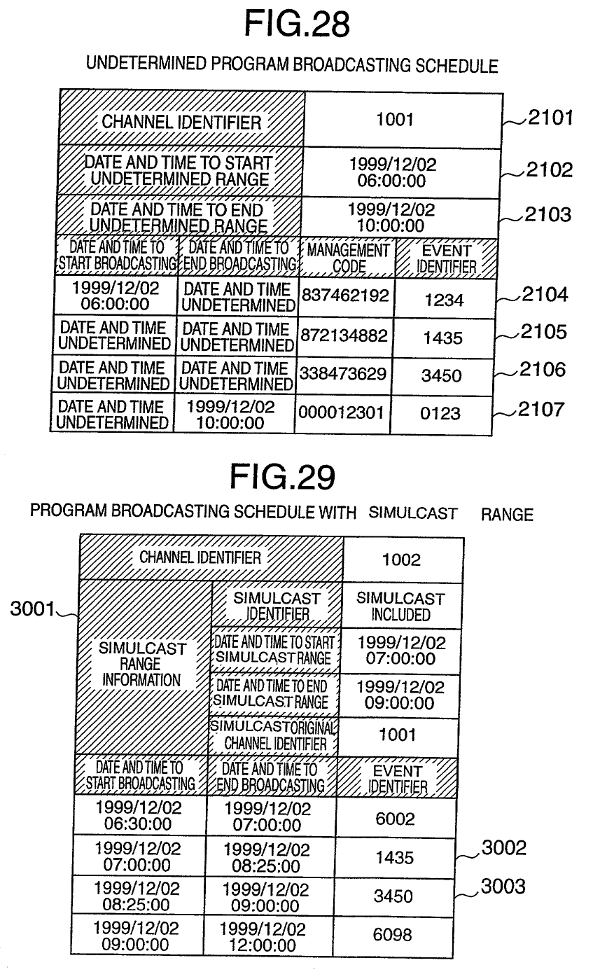

The function of the program editing device 201 is the same as that of the first embodiment. The undetermined program editing device 2101 can edit an undetermined program broadcasting schedule in the time period in which the times to start broadcasting programs are not determined. An example of the undetermined program broadcasting schedule is shown in FIG. 28. In this undetermined program broadcasting schedule, a date and time 2102 to start broadcasting programs in an undetermined range and a time an date 2103 to end broadcasting the programs in the undetermined range are registered. Further, in the undetermined program broadcasting schedule, except for the date and time to start broadcasting of the first entry 2104 and the date and time to end broadcasting of the last entry 2107, the times and dates to start and end broadcasting of all other entries are “undetermined”, and programs are broadcast in the order they are registered. The undetermined program editing device 2101 outputs the edited undetermined program broadcasting schedule to the data server 202.

The data server 202 manages all the received program broadcasting schedules and undetermined program broadcasting schedules of all channels and all the received program information and outputs the program broadcasting schedule, undetermined program broadcasting schedule and program information registered in the program editing device 201 or the undetermined program editing device 2101 to the program guide information-generating device 203 periodically, instantaneously or according to the request made by the program guide information-generating device 203. For example, the data server 202 immediately outputs the undetermined program broadcasting schedule received from the undetermined program editing device 2101 to the program guide information-generating device 203.

The input block 211 and schedule event information-generating block 213 of the program guide information-generating device 203 carry out the same processes as in the above first embodiment when receiving the program broadcasting schedule and the program information.

The simulcast range processing block 212 is the same as that of the above first embodiment except that when a simulcast range is replaced with the program broadcasting schedule of a simulcast original channel by the simulcast range process, the program broadcasting schedule before replacement can be saved as a pre-replacement program broadcasting schedule.

The current/next event information-generating block 214 performs the same process as that of the above first embodiment except that it outputs received program information to the single-event information for a simulcast range-generating block 2102 and receives single-event information for a simulcast range.

After receiving the program information, the single-event information for a simulcast range-generating block 2102 generates single-event information for a simulcast range. The single-event information for a simulcast range is single-event information prepared by combining a event identifier and the channel identifier of a simulcast other channel in preparation for the time when the program is broadcast on the simulcast other channel.

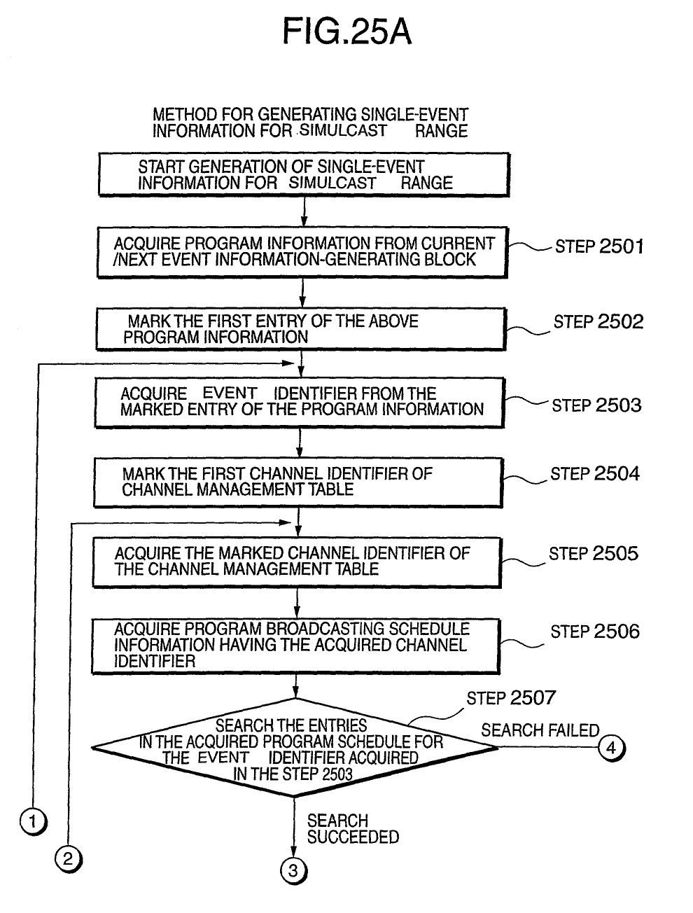

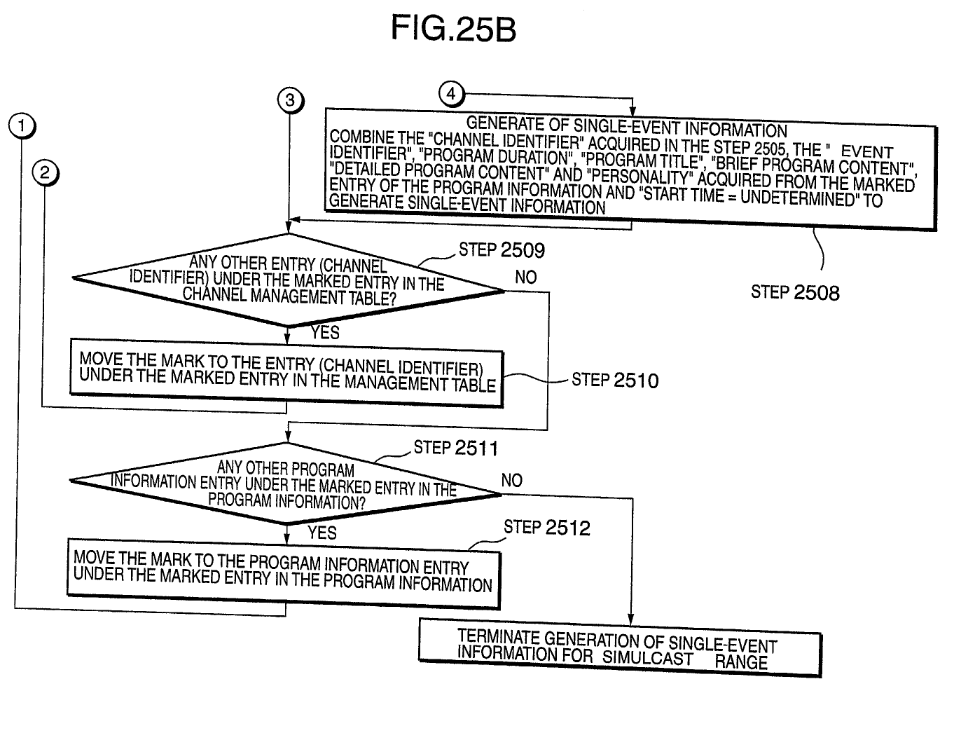

A method for generating this single-event information for a simulcast range will be described with reference to FIG. 25.

Step 2501: The single-event information for a simulcast range-generating block 2102 acquires program information from the current/next event information-generating block 214,

Step 2502: marks the first entry of the program information, and

Step 2503: acquires a event identifier from the marked entry of the program information.

Step 2504: Then, mark the first channel identifier of a channel management table, and

Step 2505: Acquire the marked channel identifier of the channel management table.

Step 2506: Acquire program broadcasting schedule information having the acquired channel identifier, and

Step 2507: Search the entries in the acquired program schedule for the event identifier acquired in the step 2503. When the search was not successful,

Step 2508: combine the “channel identifier” acquired in the step 2505, the “event identifier”, “program duration”, “program title”, “brief program content”, “detailed program content” and “personality” acquired from the marked entry of the program information and “start time=undetermined” to generate single-event information.

When the search was successful in the step 2507 or after the step 2508,

Step 2509: check whether there is any other entry (channel identifier) under the marked entry in the channel management table. When there is other entry,

Step 2510: move the mark to the entry (channel identifier) under the marked entry in the management table, returns to the step 2505 and repeats the subsequent steps.

Meanwhile, when there is no other channel identifier entry in the step 2509,

Step 2511: check whether there is other program information entry under the marked entry in the program information. When there is other entry,

Step 2512: move the mark to the program information entry under the marked entry in the program information, returns to the step 2503 and repeats the subsequent steps.

Further, when there is no other entry in the step 2511, the preparation of the single-event information for a simulcast range is terminated.

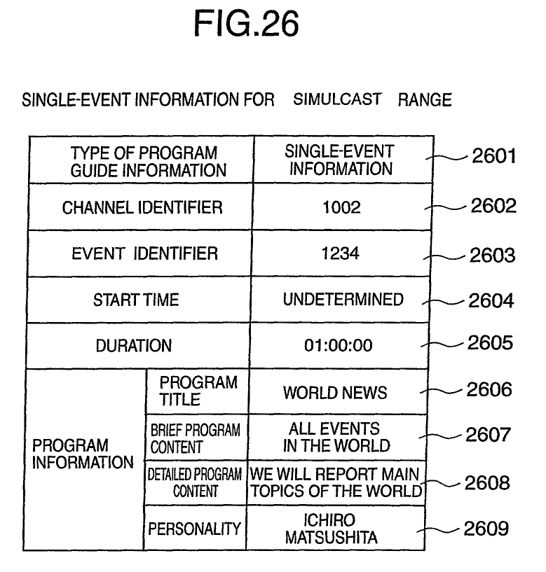

An example of the single-event information for a simulcast range is shown in FIG. 26. FIG. 26 shows single-event information for a simulcast range which is used when a program with a event identifier “1234” to be broadcast on a simulcast original channel “1001” is broadcast on a simulcast other channel identifier “1002” indicated by 2602.

Next, a description will be given to the process when the program guide information-generating device 203 receives an undetermined program broadcasting schedule.

When the program guide information-generating device 203 receives an undetermined program broadcasting schedule, the program guide information-generating device 203 generates single-event information and a current/next event information transmission schedule. In this case, schedule event information is neither generated, transmitted nor updated.

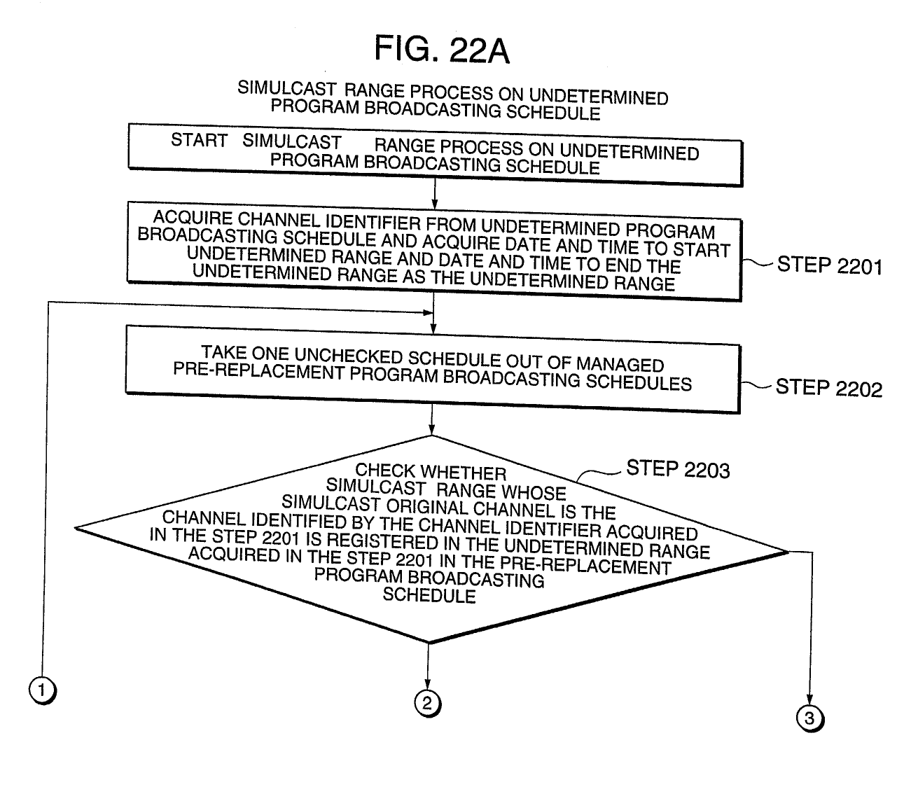

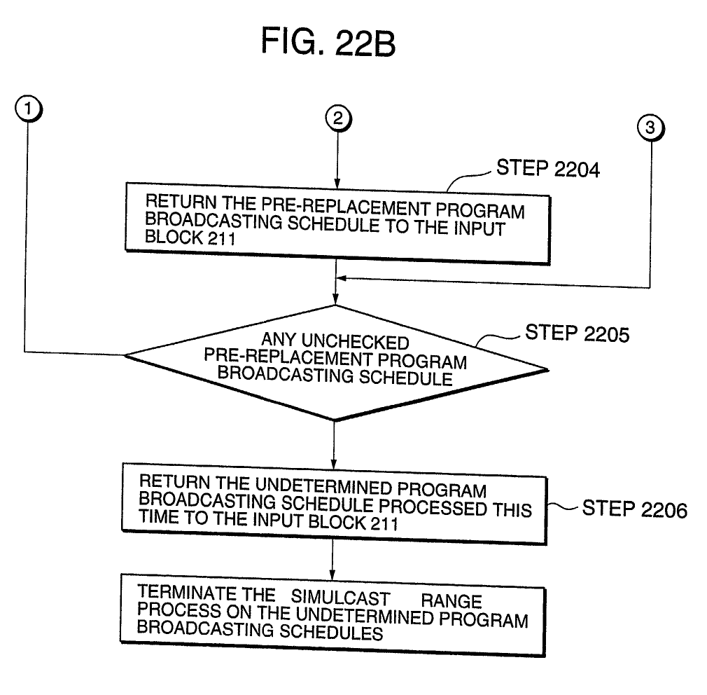

When acquiring the undetermined program broadcasting schedule, the input block 211 passes the undetermined program broadcasting schedule to the simulcast range processing block 212. When acquiring the undetermined program broadcasting schedule, the simulcast range processing block 212 conducts a simulcast range process on the undetermined program broadcasting schedule, checks whether a simulcast range whose simulcast original channel is the channel of this schedule is registered in the program guide information of other channels and, when the simulcast range is registered, passes a pre-replacement program broadcasting schedule free of the simulcast range to the input block 211. The above process will be described with reference to FIG. 22.

Step 2201: Acquire a channel identifier from an undetermined program broadcasting schedule, and acquire a date and time to start an undetermined range and a date and time to end the undetermined range as the undetermined range.

Step 2202: Take one pre-replacement program broadcasting schedule unchecked by the subsequent step 2203 out of the pre-replacement program broadcasting schedules managed by the simulcast range processing block 212 and saved in the above simulcast range process.

Step 2203: Check whether a simulcast range whose simulcast original channel is the channel identified by the channel identifier acquired in the step 2201 is registered in the undetermined range acquired in the step 2201 in the pre-replacement program broadcasting schedule.

Step 2204: When the simulcast range is registered in the step 2203, returns the pre-replacement program broadcasting schedule to the input block 211. For example, it is understood from the undetermined program broadcasting schedule of FIG. 28 that a channel identifier 2101 is “1001”, a date and time 2102 to start a undetermined range is “1999/12/02 06:00:00” and a date and time 2103 to end the undetermined range is “1999/12/02 10:00:00”. Assuming that there is a schedule with a channel identifier “1002” 601 shown in FIG. 6 as a pre-replacement program broadcasting schedule, since the “1001 simultaneous” 602 registered in the pre-replacement program broadcasting schedule falls within the above undetermined range, this pre-replacement program broadcasting schedule is output to the input block 211.

Step 2205: After the step 2204 or when the simulcast range is not registered in the step 2203, check whether there is an unchecked pre-replacement program broadcasting schedule in the pre-replacement program broadcasting schedules managed by the simulcast range processing block 212 and saved in the above simulcast range process. When there is an unchecked pre-replacement program broadcasting schedule, return to the step 2202 and repeats the subsequent steps.

Step 2206: When there is no unchecked pre-replacement program broadcasting schedule in the step 2205, return the undetermined program broadcasting schedule processed this time to the input block 211 and terminate the simulcast range process on the undetermined program broadcasting schedules.

When receiving program broadcasting schedules with simulcast ranges which are the pre-replacement program broadcasting schedules and the undetermined program broadcasting schedule from the simulcast range processing block 212, the input block 211 outputs the program broadcasting schedules with simulcast ranges and the undetermined program broadcasting schedule to the current/next event information-generating block 214.

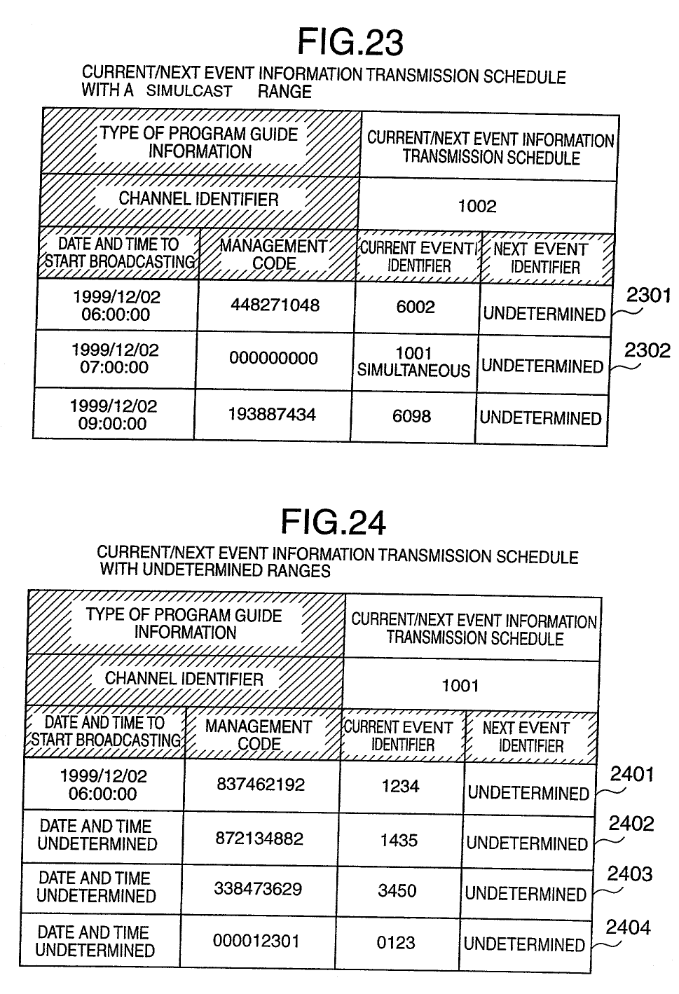

When receiving the program broadcasting schedules with simulcast ranges, the current/next event information-generating block 214 subjects the program broadcasting schedules with simulcast ranges to a process of generating a current/next event information transmission schedule to generate a current/next event information transmission schedule. The current/next event information transmission schedule is generated in the manner as described in FIG. 13 of the above first embodiment. As for a simulcast range in particular, as shown in FIG. 23, the next event identifier right before the simulcast range is set to be undetermined, and the current event identifier when the current program indicated by 2302 is within the simulcast range is set to be the simulcast range information as “1001 simultaneous” in accordance with the program broadcasting schedule.

Further, when the current/next event information-generating block 214 receives the undetermined program broadcasting schedule, it subjects the undetermined program broadcasting schedule to a process of generating a current/next event information transmission schedule to generate a current/next event information transmission schedule. The current/next event information transmission schedule is generated in the manner as described in FIG. 13 of the above first embodiment. As shown in FIG. 24, the times and dates to start broadcasting in the undetermined range are set to be “date and time unknown”, and the next event identifiers in the undetermined range are set to be “undetermined”.

The output block 215 functions in the same manner as that in the above first embodiment except that it receives single-event information for a simulcast range from the current/next event information-generating block 214 and outputs the single-event information to the program guide information-transmitting device 205.

The program initiation control device 204 functions in the same manner as that in the above first embodiment. However, it transmits a program guide notice to the program whose date and time to start broadcasting is set to be “date and time unknown” in accordance with an external trigger.

The input block 221 in the program guide information-transmitting device 205 functions in the same manner as that in the above first embodiment except that it acquires single-event information for a simulcast range from the program guide information-generating device 203 and outputs the single-event information to the current/next event information-transmitting block 223.

The schedule event information-transmitting block 224 and the output block 224 function in the same manner as those in the above first embodiment.

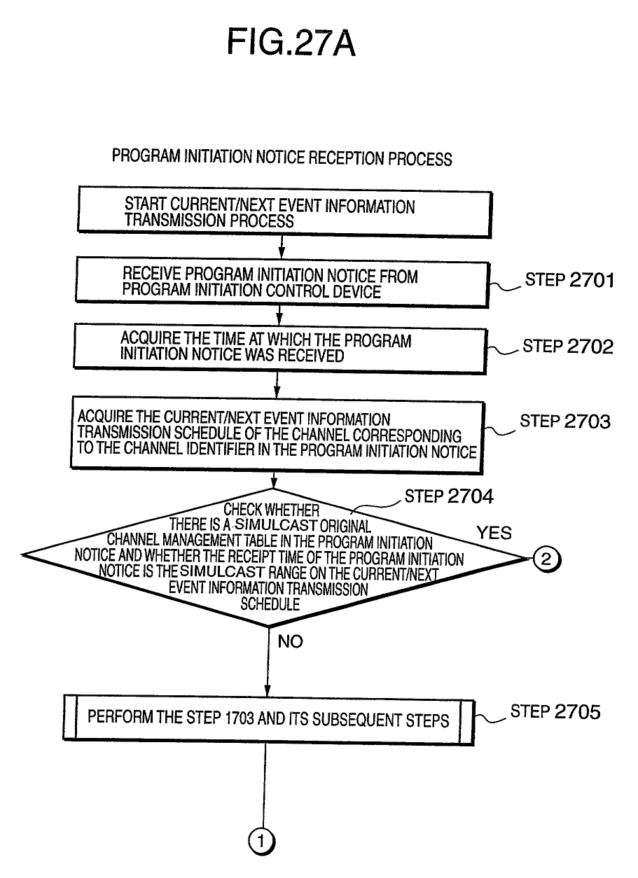

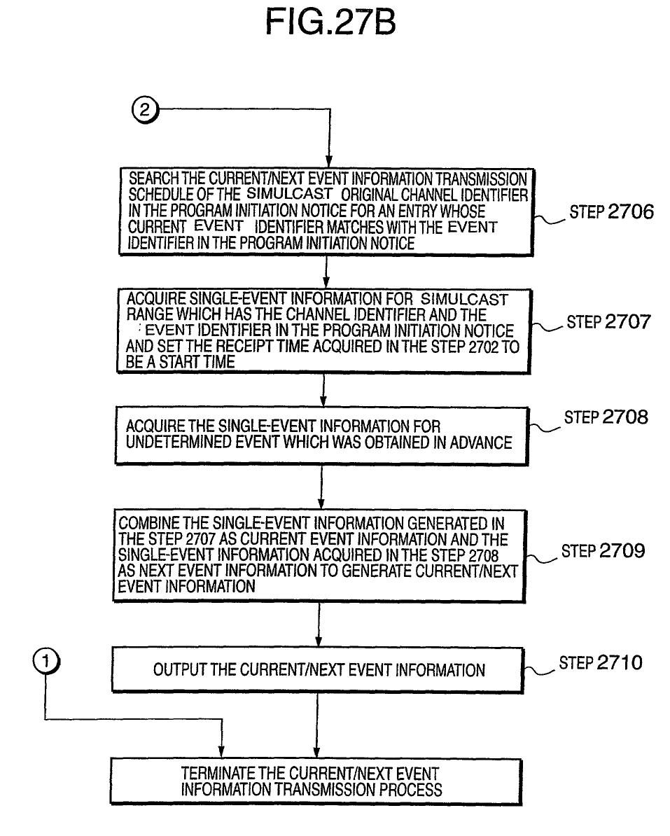

Further, when the current/next event information-transmitting block 223 receives a program initiation notice from the program initiation control device 204, it carries out the steps shown in FIG. 27. A description will be given to the steps to be carried out on receipt of the program initiation notice.

Step 2701: The current/next event information-transmitting block 223 receives a program initiation notice from the program initiation notice control device 204.

Step 2702: The current/next event information-transmitting block 223 acquires the time at which it received the program initiation notice from an internal clock which is not shown, and

Step 2703: acquires the current/next event information transmission schedule of the channel corresponding to the channel identifier in the program initiation notice.

Step 2704: Check whether there is a simulcast original channel management table in the program initiation notice and whether the receipt time of the program initiation notice is the simulcast range on the current/next event information transmission schedule. For example, it is assumed that the program initiation notice of FIG. 20 is received at the time “1999/12/02 07:00:00”. In this program initiation notice, a simulcast original channel identifier “1001” is registered in 2003. Further, it is understood that the time “1999/12/02 07:00:00” in the current/next event information transmission schedule of the concerned channel in FIG. 23 goes into a simulcast range 2302.

Step 2705: When the checks in the step 2704 are not successful, the step 1703 and its subsequent steps of FIG. 17 of the above first embodiment are carried out.

Step 2706: When the checks in the step 2704 are successful, search the current/next event information transmission schedule of the simulcast original channel identifier in the program initiation notice for an entry whose current event identifier matches with the event identifier in the program initiation notice.

Step 2707: Acquire single-event information for a simulcast range which has the channel identifier and event identifier in the program initiation notice, and set the receipt time acquired in the step 2702 to be a start time.

Step 2708: Further, the current/next event information-transmitting block 224 acquires the single-event information (single-event information at least start time and duration of which are undetermined) for an undetermined event which has been obtained in advance.

Step 2709: Combine the single-event information generated in the step 2707 as current event information and the single-event information acquired in the step 2708 as next event information to generate current/next event information.

Step 2710: Output the generated current/next event information to the output block 224, and terminate the process.

Further, in the step 1705, when the date and time to start broadcasting is undetermined, it is considered “unmatched”.

Further, in the step 2707, by acquiring single-event information having the event identifier of the simulcast original channel from the simulcast original channel identifier and the event identifier in the program initiation notice instead of acquiring single-event information for a simulcast range having the channel identifier and the event identifier in the program initiation notice, replacing the channel identifier of the single-event information with the channel identifier in the program initiation notice and using the resulting single-event information as the current event information of the current/next event information, single-event information for a simulcast range does not have to be generated in the program guide information-generating device 203 in advance and the amount of the single-event information can be restricted.

Further, as in the case of the above first embodiment, the information contained in the program initiation notice may not have to be a “event identifier” indicated by 1902 in FIG. 19 and may be a “management code” indicated by 3102 in FIG. 30. In this case, in the current/next event information transmission process in the current/next event information-transmitting block 223 shown in FIG. 17, when the method (step 2706) of searching the current/next event information transmission schedule of the simulcast original channel is carried out by using the management code in the program initiation notice and the management code in the current/next event entry in place of the event identifier in the program initiation notice and the current event identifier in the current/next event entry, the same effect can still be obtained.

Further, in the process at the time of receiving the program initiation notice shown in FIG. 27, when the current/next event entry corresponding to the program initiation notice is searched through the current/next event information transmission schedule of a simulcast original channel to generate current/next event information (Steps 2706 to 2709), single-event information for a simulcast range corresponding to the next event identifier of the current/next event entry searched through the current/next event information transmission schedule of the simulcast original channel can be used as the next event information in place of single-event information for an undetermined event.

Further, in the process at the time of receiving the program initiation notice shown in FIG. 27, when a simulcast original channel identifier is registered in the program initiation notice, by using single-event information for a simulcast range which has the channel identifier and the event identifier in the program initiation notice as current event information and single-event information for an undetermined entry as next event information instead of searching the current/next event information transmission schedule for the current/next event entry through the steps 2706 to 2709, current/next event information can be generated.

Further, when a simulcast relationship can be defined in advance, by generating single-event information for a simulcast range only for the program information of the channel which can be a simulcast original channel, the amount of single-event information for a simulcast range prepared in advance can be restricted. For example, in the case of the channels of FIG. 5. when it is defined that only channels 1001 and 1002 can be the simulcast original channels of a channel 1003, single-event information for a simulcast range in relation to a channel C is generated only for the channels 1001 and 1002, and single-event information for a simulcast range does no need to be generated for a channel 1004.

In addition, in the program broadcasting schedule of a simulcast original channel, by generating single-event information for a simulcast range only for programs having a event identifier which falls within the time range of the simulcast range of the simulcast original channel, the amount of single-event information for a simulcast range prepared in advance can be restricted.

As described above, in this system, an undetermined program broadcasting schedule in which the date and time to start broadcasting of each program is undetermined can be set by providing the undetermined program editing device 2101 to the system. When a simulcast range is registered in the undetermined program broadcasting schedule or when a schedule which falls within the simulcast range of a simulcast original channel falls within an undetermined range, it is not clear which programs are to be broadcast in the simulcast range, so that the simulcast range cannot be replaced by the schedule of the simulcast original channel. Therefore, assuming that the programs of the simulcast original channel are broadcast in the irreplaceable simulcast range, the single-event information for a simulcast range-generating block 2102 generates single-event information of different channel identifiers for each program information entry and sets the start time of the single-event information as “undetermined”.

Further, when the current/next event information-transmitting block 223 receives a program initiation notice and uses the single-event information whose start time is set to be “undetermined” as the information which matches with the channel identifier and event identifier specified in the program initiation notice, it sets the start time of the program initiation notice to be the reception time of the program initiation notice.

Thereby, even when the simulcast range in the program broadcasting schedule of a channel cannot be replaced by the program broadcasting schedule of a simulcast original channel, program guide information can be transmitted quickly in accordance with a program initiation notice.

As is obvious from the above description, the program guide information-generating/transmitting system of the present invention replaces the simulcast range information in a program broadcasting schedule with the program broadcasting schedule of a simulcast original channel even in the case of simultaneous broadcasting, it can decrease the time spent for editing the program broadcasting schedule and manage simultaneous broadcasting efficiently.

Further, even when the simulcast range cannot be replaced, program guide information can be transmitted quickly in accordance with a program initiation notice.

1. A program guide information-generating device of a program guide information-generating system, which has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast.

2. The device of claim 1, wherein the simulcast range processing block generates the program broadcasting schedule by using the date and time to start broadcasting of a program entry registered not in the program broadcasting schedule and having the simulcast identifier and the simulcast original channel identifier registered therein as the date and time to start the simulcast range and using the date and time to end broadcasting of the program entry as the date and time to end the simulcast range.

3. The device of claim 1, wherein the simulcast range processing block replaces the program entries in the simulcast range in the program broadcasting schedule having the simulcast range information registered therein with program entries whose times and dates to start broadcasting fall between the date and time to start the simulcast range and the date and time to end the simulcast range in the program broadcasting schedule corresponding to the simulcast original channel identifier contained in the simulcast range information.

4. The device of claim 1, wherein the simulcast range processing block does not perform the replacement when the date and time to start the simulcast range in the simulcast range information in the program broadcasting schedule is undetermined or when the date and time to start broadcasting of the program entry in the program broadcasting schedule corresponding to the simulcast original channel identifier in the simulcast range information is undetermined.

5. The device of claim 1, which has a current/next event information-generating block which generates single-event information having the channel identifier of a simulcast other channel from the event identifier of a program entry in the program broadcasting schedule of a simulcast original channel and the program information of the simulcast original channel when a simulcast range in a program broadcasting schedule is replaced by the program entry.

6. A program guide information-generating device of a program guide information-generating system, which has single-event information for simulcast range-generating block which generates single-event information for a simulcast range which has the channel identifier of a simulcast other channel from the event identifier of a program entry registered in the program broadcasting schedule of a simulcast original channel and the program information of the simulcast original channel in accordance with a simulcast relationship which has the relationship between the channel identifier of the simulcast other channel and the channel identifier of the simulcast original channel.

7. A program guide information-generating device of a program guide information-generating system, which has single-event information for simulcast range-generating block which generates the single-event information for a simulcast range which has the channel identifier of a simulcast other channel from the event identifier of a program entry whose time and date to start broadcasting falls between the date and time to start the simulcast range and the date and time to end the simulcast range or a program entry whose date and time to start broadcasting is undetermined in the program broadcasting schedule corresponding to the simulcast original channel identifier and the program information of the simulcast original channel when simulcast range information is registered in the program broadcasting schedule.

8. A program guide information-generating device of a program guide information-generating system, which has single-event information for simulcast range-generating block which generates the single-event information for a simulcast range which has the channel identifier of a simulcast other channel from the event identifiers of program entries registered in the program broadcasting schedules of all channels and the program information of the channel identifier.

9. A program guide information-transmitting device of a program guide information-generating system, which has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information, wherein the current/next event information is generated by current/next event information-generating means when a simulcast original channel identifier is set in the program initiation notice.

10. The device of claim 9, wherein the current/next event information-generating means acquires the event identifier of a current event from the current/next event entry in which the event identifier of the current event matches with the event identifier set in the program initiation notice in the current/next event information transmission schedule corresponding to the simulcast original channel identifier set in the program initiation identifier and uses the channel identifier of the program initiation notice, single-event information for a simulcast range in which the event identifier is set as current event information and the single-event information for an undetermined entry as next event information to generate the current/next event information.

11. The device of claim 9, wherein the current/next event information-generating means acquires the event identifier of a current event and the event identifier of a next event from the current/next event entry in which the event identifier of the current event matches with the event identifier set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

12. The device of claim 9, wherein the current/next event information-generating means specifies single-event information having the information about the simulcast original channel identifier and event identifier set in the program initiation notice, replaces the channel identifier of the single-event information with the channel identifier set in the program initiation notice and uses the single-event information as the current event information of the current/next event information to generate the current/next event information.

13. A program guide information-transmitting device of a program guide information-generating system, which has a current/next event information-transmitting block which generates current/next event information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information, wherein the current/next event information-transmitting block uses single-event information for a simulcast range which has the channel identifier and event identifier set in the program initiation notice as current event information and the single-event information for an undetermined event as next event information to generate the current/next event information when a simulcast original channel identifier is set in the program initiation notice.

14. A program guide information-transmitting device of a program guide information-generating system, which has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information, wherein the current/next event information is generated by current/next event information-generating means when the simulcast original channel identifier is set in the program initiation notice.

15. The device of claim 14, wherein the current/next event information-generating means acquires the event identifier of a current event and the event identifier of a next event from the current/next event entry in which the management code matches with the management code set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

16. The device of claim 14, wherein the current/next event information-generating means acquires the event identifier of a current event from the current/next event entry in which the management code matches with the management code set in the program initiation notice in the current/next event information transmission schedule corresponding to the simulcast original channel identifier set in the program initiation identifier and uses single-event information for a simulcast range which has the channel identifier set in the program initiation notice and the event identifier as current event information and the single-event information for an undetermined entry as next event information to generate the current/next event information.

17. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device, wherein the program guide information-generating device has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast.

18. The system of claim 17, wherein the program guide information-generating device has a current/next event information-generating block which generates single-event information having the channel identifier of a simulcast other channel from the event identifier of a program entry in the program broadcasting schedule of a simulcast original channel and the program information of the simulcast original channel when the simulcast range in the program broadcasting schedule is replaced by the program entry in the program broadcasting schedule of the simulcast original channel.

19. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device, wherein the program guide information-generating device has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast,
the simulcast range processing block does not perform the replacement when the date and time to start the simulcast range in the simulcast range information in the program broadcasting schedule is undetermined or when the date and time to start broadcasting of the program entry in the program broadcasting schedule corresponding to the simulcast original channel identifier in the simulcast range information is undetermined,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event from the current/next event entry in which the event identifier of the current event matches with the event identifier set in the program initiation notice in the current/next event information transmission schedule corresponding to the simulcast original channel identifier set in the program initiation identifier and uses the channel identifier of the program initiation notice and single-event information for a simulcast range in which the event identifier is set as current event information and the single-event information for an undetermined entry as next event information to generate the current/next event information.

20. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device, wherein the program guide information-generating device has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast,
the simulcast range processing block does not perform the replacement when the date and time to start the simulcast range in the simulcast range information in the program broadcasting schedule is undetermined or when the date and time to start broadcasting of the program entry in the program broadcasting schedule corresponding to the simulcast original channel identifier in the simulcast range information is undetermined,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event and the event identifier of a next event from the current/next event entry in which the event identifier of the current event matches with the event identifier set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

21. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device, wherein the program guide information-generating device has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast,
the simulcast range processing block does not perform the replacement when the date and time to start the simulcast range in the simulcast range information in the program broadcasting schedule is undetermined or when the date and time to start broadcasting of the program entry in the program broadcasting schedule corresponding to the simulcast original channel identifier in the simulcast range information is undetermined,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means specifies single-event information having the information about the simulcast original channel identifier and event identifier set in the program initiation notice, replaces the channel identifier of the single-event information with the channel identifier set in the program initiation notice and uses the single-event information as the current event information of the current/next event information to generate the current/next event information.

22. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device, wherein the program guide information-generating device has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast,
the simulcast range processing block does not perform the replacement when the date and time to start the simulcast range in the simulcast range information in the program broadcasting schedule is undetermined or when the date and time to start broadcasting of the program entry in the program broadcasting schedule corresponding to the simulcast original channel identifier in the simulcast range information is undetermined,
the program guide information-transmitting device has a current/next event information-transmitting block which generates current/next event information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information, and
the current/next event information-transmitting block uses single-event information for a simulcast range which has the channel identifier and event identifier set in the program initiation notice as current event information and the single-event information for an undetermined event as next event information to generate the current/next event information when a simulcast original channel identifier is set in the program initiation notice.

23. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device, wherein the program guide information-generating device has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast,
the simulcast range processing block does not perform the replacement when the date and time to start the simulcast range in the simulcast range information in the program broadcasting schedule is undetermined or when the date and time to start broadcasting of the program entry in the program broadcasting schedule corresponding to the simulcast original channel identifier in the simulcast range information is undetermined,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event and the event identifier of a next event from the current/next event entry in which the management code matches with the management code set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

24. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device, wherein the program guide information-generating device has a simulcast range processing block which generates a program broadcasting schedule by replacing the program entries in a simulcast range with the program entries registered in the program broadcasting schedule of a simulcast original channel identifier when simulcast range information comprising the simulcast range having a date and time to start the simulcast range and a date and time to end the simulcast range, a simulcast identifier and the simulcast original channel identifier is registered to represent some or all of the program entries in the program broadcasting schedule of each channel in which program entries each of which having a date and time to start broadcasting and a event identifier are registered in the order they are broadcast,
the simulcast range processing block does not perform the replacement when the date and time to start the simulcast range in the simulcast range information in the program broadcasting schedule is undetermined or when the date and time to start broadcasting of the program entry in the program broadcasting schedule corresponding to the simulcast original channel identifier in the simulcast range information is undetermined,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event from the current/next event entry in which the management code matches with the management code set in the program initiation notice in the current/next event information transmission schedule corresponding to the simulcast original channel identifier set in the program initiation identifier and uses single-event information for a simulcast range which has the channel identifier set in the program initiation notice and the event identifier as current event information and the single-event information for an undetermined entry as next event information to generate the current/next event information.

25. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates single-event information for a simulcast range which has the channel identifier of a simulcast other channel from the event identifier of a program entry registered in the program broadcasting schedule of a simulcast original channel and the program information of the simulcast original channel in accordance with a simulcast relationship which has the relationship between the channel identifier of the simulcast other channel and the channel identifier of the simulcast original channel,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event from the current/next event entry in which the event identifier of the current event matches with the event identifier set in the program initiation notice in the current/next event information transmission schedule corresponding to the simulcast original channel identifier set in the program initiation identifier and uses the channel identifier of the program initiation notice and single-event information for a simulcast range in which the event identifier is set as current event information and the single-event information for an undetermined entry as next event information to generate the current/next event information.

26. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates single-event information for a simulcast range which has the channel identifier of a simulcast other channel from the event identifier of a program entry registered in the program broadcasting schedule of a simulcast original channel and the program information of the simulcast original channel in accordance with a simulcast relationship which has the relationship between the channel identifier of the simulcast other channel and the channel identifier of the simulcast original channel,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event and the event identifier of a next event from the current/next event entry in which the event identifier of the current event matches with the event identifier set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

27. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates single-event information for a simulcast range which has the channel identifier of a simulcast other channel from the event identifier of a program entry registered in the program broadcasting schedule of a simulcast original channel and the program information of the simulcast original channel in accordance with a simulcast relationship which has the relationship between the channel identifier of the simulcast other channel and the channel identifier of the simulcast original channel,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means specifies single-event information having the information about the simulcast original channel identifier and event identifier set in the program initiation notice, replaces the channel identifier of the single-event information with the channel identifier set in the program initiation notice and uses the single-event information as the current event information of the current/next event information to generate the current/next event information.

28. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates single-event information for a simulcast range which has the channel identifier of a simulcast other channel from the event identifier of a program entry registered in the program broadcasting schedule of a simulcast original channel and the program information of the simulcast original channel in accordance with a simulcast relationship which has the relationship between the channel identifier of the simulcast other channel and the channel identifier of the simulcast original channel,
the program guide information-transmitting device has a current/next event information-transmitting block which generates current/next event information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information, and
the current/next event information-transmitting block uses single-event information for a simulcast range which has the channel identifier and event identifier set in the program initiation notice as current event information and the single-event information for an undetermined event as next event information to generate the current/next event information when a simulcast original channel identifier is set in the program initiation notice.

29. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates single-event information for a simulcast range which has the channel identifier of a simulcast other channel from the event identifier of a program entry registered in the program broadcasting schedule of a simulcast original channel and the program information of the simulcast original channel in accordance with a simulcast relationship which has the relationship between the channel identifier of the simulcast other channel and the channel identifier of the simulcast original channel,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event and the event identifier of a next event from the current/next event entry in which the management code matches with the management code set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

30. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates single-event information for a simulcast range which has the channel identifier of a simulcast other channel from the event identifier of a program entry registered in the program broadcasting schedule of a simulcast original channel and the program information of the simulcast original channel in accordance with a simulcast relationship which has the relationship between the channel identifier of the simulcast other channel and the channel identifier of the simulcast original channel,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event from the current/next event entry in which the management code matches with the management code set in the program initiation notice in the current/next event information transmission schedule corresponding to the simulcast original channel identifier set in the program initiation identifier and uses single-event information for a simulcast range which has the channel identifier set in the program initiation notice and the event identifier as current event information and the single-event information for an undetermined entry as next event information to generate the current/next event information.

31. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifier of a program entry whose time and date to start broadcasting falls between the date and time to start the simulcast range and the date and time to end the simulcast range or a program entry whose date and time to start broadcasting is undetermined in the program broadcasting schedule corresponding to the simulcast original channel identifier and the program information of the simulcast original channel when simulcast range information is registered in the program broadcasting schedule,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event from the current/next event entry in which the event identifier of the current event matches with the event identifier set in the program initiation notice in the current/next event information transmission schedule corresponding to the simulcast original channel identifier set in the program initiation identifier and uses the channel identifier of the program initiation notice and single-event information for a simulcast range in which the event identifier is set as current event information and the single-event information for an undetermined entry as next event information to generate the current/next event information.

32. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifier of a program entry whose time and date to start broadcasting falls between the date and time to start the simulcast range and the date and time to end the simulcast range or a program entry whose date and time to start broadcasting is undetermined in the program broadcasting schedule corresponding to the simulcast original channel identifier and the program information of the simulcast original channel when simulcast range information is registered in the program broadcasting schedule,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event and the event identifier of a next event from the current/next event entry in which the event identifier of the current event matches with the event identifier set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

33. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifier of a program entry whose time and date to start broadcasting falls between the date and time to start the simulcast range and the date and time to end the simulcast range or a program entry whose date and time to start broadcasting is undetermined in the program broadcasting schedule corresponding to the simulcast original channel identifier and the program information of the simulcast original channel when simulcast range information is registered in the program broadcasting schedule,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means specifies single-event information having the information about the simulcast original channel identifier and event identifier set in the program initiation notice, replaces the channel identifier of the single-event information with the channel identifier set in the program initiation notice and uses the single-event information as the current event information of the current/next event information to generate the current/next event information.

34. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifier of a program entry whose time and date to start broadcasting falls between the date and time to start the simulcast range and the date and time to end the simulcast range or a program entry whose date and time to start broadcasting is undetermined in the program broadcasting schedule corresponding to the simulcast original channel identifier and the program information of the simulcast original channel when simulcast range information is registered in the program broadcasting schedule,
the program guide information-transmitting device has a current/next event information-transmitting block which generates current/next event information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information, and
the current/next event information-transmitting block uses single-event information for a simulcast range which has the channel identifier and event identifier set in the program initiation notice as current event information and the single-event information for an undetermined event as next event information to generate the current/next event information when a simulcast original channel identifier is set in the program initiation notice.

35. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifier of a program entry whose time and date to start broadcasting falls between the date and time to start the simulcast range and the date and time to end the simulcast range or a program entry whose date and time to start broadcasting is undetermined in the program broadcasting schedule corresponding to the simulcast original channel identifier and the program information of the simulcast original channel when simulcast range information is registered in the program broadcasting schedule,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event and the event identifier of a next event from the current/next event entry in which the management code matches with the management code set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

36. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifier of a program entry whose time and date to start broadcasting falls between the date and time to start the simulcast range and the date and time to end the simulcast range or a program entry whose date and time to start broadcasting is undetermined in the program broadcasting schedule corresponding to the simulcast original channel identifier and the program information of the simulcast original channel when simulcast range information is registered in the program broadcasting schedule,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event from the current/next event entry in which the management code matches with the management code set in the program initiation notice in the current/next event information transmission schedule corresponding to the simulcast original channel identifier set in the program initiation identifier and uses single-event information for a simulcast range which has the channel identifier set in the program initiation notice and the event identifier as current event information and the single-event information for an undetermined entry as next event information to generate the current/next event information.

37. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifiers of program entries registered in the program broadcasting schedules of all channels and the program information of the channel identifier,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event from the current/next event entry in which the event identifier of the current event matches with the event identifier set in the program initiation notice in the current/next event information transmission schedule corresponding to the simulcast original channel identifier set in the program initiation identifier and uses the channel identifier of the program initiation notice and single-event information for a simulcast range in which the event identifier is set as current event information and the single-event information for an undetermined entry as next event information to generate the current/next event information.

38. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifiers of program entries registered in the program broadcasting schedules of all channels and the program information of the channel identifier,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means acquires the event identifier of a current event and the event identifier of a next event from the current/next event entry in which the event identifier of the current event matches with the event identifier set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

39. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifiers of program entries registered in the program broadcasting schedules of all channels and the program information of the channel identifier,
the program guide information-transmitting device has a current/next event information-transmitting block which generates current/next event information by use of the information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information,
the current/next event information-transmitting block generates the current/next event information by current/next event information-generating means when a simulcast original channel identifier is set in the program initiation notice, and
the current/next event information-generating means specifies single-event information having the information about the simulcast original channel identifier and event identifier set in the program initiation notice, replaces the channel identifier of the single-event information with the channel identifier set in the program initiation notice and uses the single-event information as the current event information of the current/next event information to generate the current/next event information.

40. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifiers of program entries registered in the program broadcasting schedules of all channels and the program information of the channel identifier,
the program guide information-transmitting device has a current/next event information-transmitting block which generates current/next event information from a current/next event information transmission schedule in which current/next event entries comprising the date and time to start broadcasting of a current event, the event identifier of the current event and the event identifier of a next event are registered in the order they are broadcast, the single-event information, the single-event information for a simulcast range and a program initiation notice comprising a channel identifier and a event identifier and which transmits the current/next event information, and
the current/next event information-transmitting block uses single-event information for a simulcast range which has the channel identifier and event identifier set in the program initiation notice as current event information and the single-event information for an undetermined event as next event information to generate the current/next event information when a simulcast original channel identifier is set in the program initiation notice.

41. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifiers of program entries registered in the program broadcasting schedules of all channels and the program information of the channel identifier,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event and the event identifier of a next event from
the current/next event entry in which the management code matches with the management code set in the program initiation notice in the current/next event information transmission schedule corresponding to the simulcast original channel identifier set in the program initiation identifier and uses the channel identifier set in the program initiation notice as current event information and single-event information for a simulcast range which has the event identifier as next event information to generate the current/next event information.

42. A program guide information-generating/transmitting system comprising a program editing device which edits a program broadcasting schedule and program information, a program guide information managing device which manages edited information, a program guide information-generating device which receives the program broadcasting schedule and the program information from the program guide information managing device and generates program guide information, a program initiation control device which transmits a program initiation notice, and a program guide information-transmitting device which receives the program guide information from the program guide information-generating device and transmits the current/next event information generated from the program guide information in accordance with the program initiation notice transmitted from the program initiation control device,
wherein the program guide information-generating device has single-event information for simulcast range-generating block which generates the single-event information for a simulcast range which has the channel identifier of a simulcast other channel from the event identifiers of program entries registered in the program broadcasting schedules of all channels and the program information of the channel identifier,
the program guide information-transmitting device has a current/next event information-transmitting block which generates current/next event information from a current/next event information transmission schedule in which current/next event entries comprising the date and time to start broadcasting, management code and event identifier of a current event and the event identifier of a next event are registered in the order they are broadcast, the single-event information, the single-event information for a simulcast range and a program initiation notice comprising a channel identifier, a management code and a simulcast original channel identifier and which transmits the current/next event information,
the current/next event information-transmitting block generates the current/next event information by current/next event information-generating means when the simulcast original channel identifier is set in the program initiation notice, and
the current/next event information-generating means acquires the event identifier of a current event from the current/next event entry in which the management code matches with the management code set in the program initiation notice in the current/next event information transmission schedule corresponding to the simulcast original channel identifier set in the program initiation identifier and uses single-event information for a simulcast range which has the channel identifier set in the program initiation notice and the event identifier as current event information and the single-event information for an undetermined entry as next event information to generate the current/next event information.
